(19) United States
(12) Patent Application Publication
(10) Pub. No.: US 2026/0311707 A1
(43) Pub. Date: Oct. 8, 2026

(54) ERROR CORRECTION FOR AUDIO BITSTREAMS OUTPUT VIA WIRELESS LINKS

(71) Applicant: QUALCOMM Incorporated, San Diego, CA (US)

(72) Inventors: Richard Turner, Belfast (GB); Laurent Wojcieszak, Belfast (GB); Derrick Rea, Broughshane (GB); Megan Lucy Taggart, Newtownabbey (GB)

(21) Appl. No.: 19/564,651

(22) Filed: Mar. 12, 2026

Related U.S. Application Data
(60) Provisional application No. 63/783,846, filed on Apr. 4, 2025.

(51) Int. Cl. G10L 19/005; H04L 1/00

(52) U.S. Cl. CPC G10L 19/005; H04L 1/0041; H04L 1/0056

(57) ABSTRACT

A device comprising a memory and processing circuitry may be configured to implement the techniques. The memory may be configured to store an encoded audio bitstream representative of the audio data. The processing circuitry may be in communication with the memory and configured to obtain, from the encoded audio bitstream, error correction data, determine that at least a portion of the encoded audio bitstream is corrupted, and perform error correction, based on the error correction data, to recover at least the portion of the encoded audio bitstream and obtain error corrected audio data. The processing circuitry may also be configured to insert the error corrected audio data into the encoded audio bitstream, decode the encoded audio bitstream to obtain decoded audio data, render, based on the decoded audio data, one or more speaker feeds, and output, for playback, the one or more speaker feeds.

This application claims the benefit of U.S. Provisional Application No. 63/783,846, filed Apr. 4, 2025, the entire contents of which are hereby incorporated by reference.

This application is related to:
U.S. Provisional Application No. 63/656,497, filed Jun. 5, 2024;
U.S. Provisional Application No. 63/781,054, filed Mar. 31, 2025; and
U.S. Provisional Application No. 63/781,767, filed Apr. 1, 2025,
the entire contents of all of the foregoing U.S. Provisional Applications are hereby incorporated by reference.

### TECHNICAL FIELD

This disclosure relates to audio encoding and decoding.

### BACKGROUND

Wireless networks for short-range communication, which may be referred to as “personal area networks,” are established to facilitate communication between a source device and a sink device. One example of a personal area network (PAN) protocol is Bluetooth®, which is often used to form a PAN for streaming audio data from the source device (e.g., a mobile phone) to the sink device (e.g., headphones or a speaker).

In some examples, the Bluetooth® protocol is used for streaming encoded or otherwise compressed audio data. There is demand for lossless encoded audio data, which refers to a process in which the audio data is encoded with little to no loss of accuracy relative to the original audio data (e.g., bit exact between the original audio data and decoded audio data decoded from the encoded audio data). Currently, Bluetooth® and other PAN protocols only provide limited support for transmission of lossless encoded audio data due to bandwidth (as lossless encoded audio data may consume more bandwidth compared to lossy encoded audio data) and in some instances latency limitations (e.g., for latency sensitive streaming, such as streaming audio data for gaming).

As a result, most lossless encoded audio data is transmitted via higher throughput network protocols, such as wireless network protocols that conform to the Institute of Electrical and Electronics Engineering (IEEE) 802.11 suite of protocols (e.g., WiFi™) and/or other network protocols. However, in many instances, latency sensitive applications (such as streaming applications, including gaming) suffer due to latency issues (e.g., due to a poor connection, network congestion, etc.) that increases dropped packets. Given that latency sensitive applications require audio and/or other data to be delivered within a limited set amount of time, WiFi may be unable to resend packets within the limited set amount of time, resulting in dropped packets that impact the quality of lossless audio encoded data.

Moreover, the industry is looking to provide lossless audio codecs (where the term “codecs” may refer to the combination of the audio encoder and the reciprocal audio decoder) that can accommodate reduced bandwidth transmission links (whether via PAN and/or other wireless networks) while still being resilient to network failures (e.g., that may result in dropped packets). While fixed-point implementations of the lossless audio codec may achieve these competing requirements of resilient reduced bandwidth transmission links, often such implementations suffer various drawbacks (such as not incorporating error correction, not scaling to accommodate network congestion, not adequately adapting to the latency demands of latency sensitive applications, etc.) and may require significant time and resources (e.g., money, manpower, etc.) to develop and validate. Further, these dedicated lossless audio codecs may not gain traction in terms of wide-spread adoption resulting in wasted time and resources.

### SUMMARY

In general, this disclosure relates to techniques for enabling lossless audio encoding that is scalable to accommodate both transmission link resiliency and latency demands. The lossless audio encoding provided by way of various aspects of the techniques may leverage existing lossy or lossless audio codecs (where again the term “codecs” may refer to the combination of the audio encoder and the reciprocal audio decoder), layering a so-called quantization offset on top of the audio codecs to facilitate bit exactness within a tolerable level (e.g., a set number of bit differences between the original audio data and the decoded audio data decoded from the encoded audio data). The audio encoding device may specify the quantization offset in an encoded audio bitstream such that the audio decoding device may adapt or otherwise adjust the decoded audio data to obtain adjusted audio data that is within the tolerable level of bit exactness.

In this way, various aspects of the techniques may allow for lossless audio coding regardless of the underlying audio codec that is used to remove or reduce any correlation within the original audio data. That is, given that the quantization offset is applied after fully decoding the encoded audio bitstream, the various aspects of the techniques described in this disclosure may be agnostic to the underlying audio codec, thereby allowing rapid development of lossless audio codecs as existing lossy or lossless codecs may be employed, thereby reducing development costs, time to market, etc. Further, the lossless audio codec enabled by way of the techniques described in this disclosure may allow for the addition of error correction, scalability (in terms of bandwidth consumption), and adaptability (in terms of providing quantization offsets that achieve varying levels of bit exactness) as a result of applying the quantization offset after the existing audio decoder performs audio decoding with respect to the audio encoded bitstream. In this way, the lossless audio codec may accommodate both transmission link resiliency and latency demands.

Moreover, the lossless audio codec enabled by various aspects of the techniques described in this disclosure may allow for varying differences in the underlying hardware architecture that may inject errors. For example, processing circuitry that implements the lossless audio encoder may perform rounding and/or other mathematical operations (such as a fast Fourier transform—FFT, a modified discrete cosine transform DCT, etc.) in a manner that differs from processing circuitry that implements that lossless audio decoder, resulting in potential difficulties to ensure bit exactness within the tolerable level. In addition, the implementation of the lossless audio encoder may differ slightly from the implementation of the lossless audio decoder that results in difficulties ensuring bit exactness within the tolerable level. The lossless audio codec enabled by way of the techniques described herein may overcome these difficulties with relatively minor bit overhead (e.g., in terms of specifying the quantization offset in the encoded audio bitstream) and development, thereby potentially promoting reduced development resource consumption (e.g., in terms of costs, time to market, manpower, etc.), which again is a result of the addition of the quantization offset after audio decoding is performed.

Further, the lossless audio codec may perform error correction, where the audio encoder may perform a form of error correction referred to as forward error correction (FEC) although other forms of error correction may be performed. The audio encoder may perform FEC through a process in which various segments, samples, portions, blocks, etc. of the audio bitstream are compared to one another (e.g., via a logical exclusive OR operation, which is often denoted as “XOR”) to obtain FEC blocks. The audio encoder may specify this FEC data into the audio bitstream, which the audio decoder may use to perform FEC in order to recover lost, missing, or corrupted segments of the audio data extracted from the bitstream. The audio encoder may add the FEC blocks to the bitstream to improve reconstruction of the audio data and allow for lower latency reconstruction.

The audio encoder may provide FEC to minimize streaming latency in certain contexts (such as gaming) when there may only be time to send two retries over a wireless link. These FEC blocks may allow for 9 error recovery attempts instead of 3, as there may be limits to the number of attempts when transmitting the encoded audio bitstream over, as an example, a WiFi™ access point (AP) and using FEC may improve the reliability of the wireless link. While implementing FEC may introduce some additional bit overhead to the encoded audio bitstream (due to the inclusion of the FEC blocks), the FEC blocks may, possibly in combination with the quantization offset, allow for lossless audio coding in streaming contexts that accommodates the stringent latency requirements of streaming contexts.

As one example, various aspects of the techniques are directed to a device configured to decode audio data, the device comprising: a memory configured to store an encoded audio bitstream representative of the audio data; and processing circuitry in communication with the memory, the processing circuitry configured to: decode the encoded audio bitstream to obtain decoded audio data; obtain, from the encoded audio bitstream, a quantization offset; apply the quantization offset to the decoded audio data to obtain corrected audio data, wherein the quantization offset corrects for any bit differences between original audio data that was encoded to obtain the encoded audio bitstream and the decoded audio data; render, based on the decoded audio data, one or more speaker feeds; and output, for playback, the one or more speaker feeds.

As another example, various aspects of the techniques are directed to a method of decoding audio data, the method comprising: decoding an encoded audio bitstream representative of the audio data to obtain decoded audio data; obtaining, from the encoded audio bitstream, a quantization offset; applying the quantization offset to the decoded audio data to obtain corrected audio data, wherein the quantization offset corrects for any bit differences between original audio data that was encoded to obtain the encoded audio bitstream and the decoded audio data; rendering, based on the decoded audio data, one or more speaker feeds; and outputting, for playback, the one or more speaker feeds.

As another example, various aspects of the techniques are directed to a computer program product including a non-transitory computer readable media storing instructions that, when executed, cause one or more processors to: decode an encoded audio bitstream representative of audio data to obtain decoded audio data; obtain, from the encoded audio bitstream, a quantization offset; apply the quantization offset to the decoded audio data to obtain corrected audio data, wherein the quantization offset corrects for any bit differences between original audio data that was encoded to obtain the encoded audio bitstream and the decoded audio data; render, based on the decoded audio data, one or more speaker feeds; and output, for playback, the one or more speaker feeds.

As another example, various aspects of the techniques are directed to a device configured to encode audio data, the device comprising: a memory configured to store the audio data; and processing circuitry in communication with the memory, the processing circuitry configured to: encode the audio data to obtain an encoded audio bitstream; decode the encoded audio bitstream to obtain corresponding decoded audio data; obtain, based on the audio data and the corresponding decoded audio data, a quantization offset; specify, in the encoded audio bitstream, the quantization offset; and output the encoded audio bitstream.

As another example, various aspects of the techniques are directed to a method of encoding audio data, the method comprising: encoding the audio data to obtain an encoded audio bitstream; decoding the encoded audio bitstream to obtain corresponding decoded audio data; obtaining, based on the audio data and the corresponding decoded audio data, a quantization offset; specifying, in the encoded audio bitstream, the quantization offset; and outputting the encoded audio bitstream.

As another example, various aspects of the techniques are directed to a computer program product comprising non-transitory computer readable media storing instructions that, when executed, cause one or more processors to: encode audio data to obtain an encoded audio bitstream; decode the encoded audio bitstream to obtain corresponding decoded audio data; obtain, based on the audio data and the corresponding decoded audio data, a quantization offset; specifying, in the encoded audio bitstream, the quantization offset; and outputting the encoded audio bitstream.

As another example, various aspects of the techniques are directed to a device configured to decode audio data, the device comprising: a memory configured to store an encoded audio bitstream representative of the audio data; and processing circuitry in communication with the memory, the processing circuitry configured to: obtain, from the encoded audio bitstream, error correction data; determine that at least a portion of the encoded audio bitstream is corrupted; perform error correction, based on the error correction data, to recover at least the portion of the encoded audio bitstream and obtain error corrected audio data; insert the error corrected audio data into the encoded audio bitstream; decode the encoded audio bitstream to obtain decoded audio data; render, based on the decoded audio data, one or more speaker feeds; and output, for playback, the one or more speaker feeds.

As another example, various aspects of the techniques are directed to a method of decoding audio data, the method comprising: obtaining, from an encoded audio bitstream representative of the audio data, error correction data; decoding the encoded audio bitstream representative to obtain decoded audio data; determining that at least a portion of the encoded audio bitstream is corrupted; performing error correction, based on the error correction data, to recover at least the portion of the encoded audio bitstream and obtain error corrected audio data; inserting the error corrected audio data into the encoded audio bitstream; decode the encoded audio bitstream to obtain decoded audio data; rendering, based on the decoded audio data, one or more speaker feeds; and outputting, for playback, the one or more speaker feeds.

As another example, various aspects of the techniques are directed to a computer program product including a non-transitory computer readable media storing instructions that, when executed, cause on or more processors to: obtain, from an encoded audio bitstream representative of audio data, error correction data; determine that at least a portion of the encoded audio bitstream is corrupted; perform error correction, based on the error correction data, to recover at least the portion of the encoded audio bitstream and obtain error corrected audio data; insert the error corrected audio data into the encoded audio bitstream; decode the encoded audio bitstream to obtain decoded audio data; render, based on the decoded audio data, one or more speaker feeds; and output, for playback, the one or more speaker feeds.

As another example, various aspects of the techniques are directed to a device configured to encode audio data, the device comprising: a memory configured to store the audio data; and processing circuitry in communication with the memory, the processing circuitry configured to: perform error correction with respect to the audio data to obtain error correction data; encode the audio data to obtain an encoded audio bitstream; specify, in the encoded audio bitstream, the error correction data; and output the encoded audio bitstream as a stream of packets via a wireless link.

As another example, various aspects of the techniques are directed to a method of encoding audio data, the method comprising: performing error correction with respect to the audio data to obtain error correction data; encoding the audio data to obtain an encoded audio bitstream; specifying, in the encoded audio bitstream, the error correction data; and outputting the encoded audio bitstream as a stream of packets via a wireless link.

As another example, various aspects of the techniques are directed to a computer program product comprising non-transitory computer readable media storing instructions that, when executed, cause one or more processors to: perform error correction with respect to audio data to obtain error correction data; encode the audio data to obtain an encoded audio bitstream; specify, in the encoded audio bitstream, the error correction data; and output the encoded audio bitstream as a stream of packets via a wireless link.

The details of one or more aspects of the techniques are set forth in the accompanying drawings and the description below. Other features, objects, and advantages of these techniques will be apparent from the description and drawings, and from the claims.

### BRIEF DESCRIPTION OF DRAWINGS

FIG. 1 is a diagram illustrating a system 10 that may perform various aspects of the techniques described in this disclosure for enabling codec agnostic lossless audio coding in accordance with various aspects of the techniques described in this disclosure.

FIG. 2 is a block diagram illustrating an example of the audio encoder 24 configured to perform various aspects of the lossless audio encoding techniques described in this disclosure.

FIG. 3A-3F are block diagrams illustrating examples of an audio encoder that includes error correction in accordance with various aspects of the techniques described in this disclosure.

FIG. 4 is a flowchart illustrating example operation of the source device of FIG. 1 in performing various aspects of the techniques described in this disclosure.

FIG. 5 is a block diagram illustrating an example audio decoder configured to perform various aspects of the techniques described in this disclosure.

FIG. 6 is a flowchart illustrating example operation of the sink device of FIG. 1 in performing various aspects of the techniques described in this disclosure.

FIG. 7 is a block diagram illustrating example components of the source device shown in the example of FIG. 1.

FIG. 8 is a block diagram illustrating exemplary components of the sink device shown in the example of FIG. 1.

FIG. 9 is a table illustrating example wireless connection latency for various modulation modes and the impact on possible lossless audio encoding performed in accordance with various aspects of the techniques described in this disclosure.

FIG. 10 is a flowchart illustrating example operation of the source device of FIG. 1 in performing various aspects of the techniques described in this disclosure.

FIG. 11 is a flowchart illustrating example operation of the sink device of FIG. 1 in performing various aspects of the techniques described in this disclosure.

### DETAILED DESCRIPTION

In general, this disclosure relates to techniques for enabling lossless audio encoding that is both scalable to accommodate both transmission link resiliency and latency demands. The lossless audio encoding provided by way of various aspects of the techniques may leverage existing lossy or lossless audio codecs (where again the term “codecs” may refer to the combination of the audio encoder and the reciprocal audio decoder), layering a so-called quantization offset on top of the audio codecs to facilitate bit exactness within a tolerable level (e.g., a set number of bit differences between the original audio data and the decoded audio data decoded from the encoded audio data). The audio encoding device may specify the quantization offset in an encoded audio bitstream such that the audio decoding device may adapt or otherwise adjust the decoded audio data to obtain adjusted audio data that is within the tolerable level of bit exactness.

As such, rather than develop a dedicated fixed-point implementation of a lossless audio codec (which may take considerably more time compared to utilizing a floating-point implementation of a lossless audio codec), the lossless audio codec enabled by way of the techniques described herein may allow for use of any existing audio codec (whether a lossy fixed-point or floating-point implementation of a lossy audio codec, a lossless fixed-point or floating-point implementation of a lossy audio codec, and the like) while still ensuring bit exactness within a tolerable level (which may be designer specified or dynamically determined) through application of the quantization offset after decoding the encoded audio bitstream output by the lossless audio encoder.

In this way, various aspects of the techniques may allow for lossless audio coding regardless of the underlying audio codec that is used to remove or reduce any correlation within the original audio data. That is, given that the quantization offset is applied after fully decoding the encoded audio bitstream, the various aspects of the techniques described in this disclosure may be agnostic to the underlying audio codec, thereby allowing rapid development of lossless audio codecs as existing lossy or lossless codecs may be employed, thereby reducing development costs, time to market, etc. Further, the lossless audio codec enabled by way of the techniques described in this disclosure may allow for the addition of error correction, scalability (in terms of bandwidth consumption), and adaptability (in terms of providing quantization offsets that achieve varying levels of bit exactness) as a result of applying the quantization offset after the existing audio decoder performs audio decoding with respect to the audio encoded bitstream. In this way, the lossless audio codec may accommodate both transmission link resiliency and latency demands.

Moreover, the lossless audio codec enabled by various aspects of the techniques described in this disclosure may allow for varying differences in the underlying hardware architecture that may inject errors. For example, processing circuitry that implements the lossless audio encoder may perform rounding and/or other mathematical operations (such as a fast Fourier transform—FFT, a modified discrete cosine transform DCT, etc.) in a manner that differs from processing circuitry that implements the lossless audio decoder, resulting in potential difficulties to ensure bit exactness within the tolerable level. In addition, the implementation of the lossless audio encoder may differ slightly from the implementation of the lossless audio decoder that results in difficulties ensuring bit exactness within the tolerable level. The lossless audio codec enabled by way of the techniques described herein may overcome these difficulties with relatively minor bit overhead (e.g., in terms of specifying the quantization offset in the encoded audio bitstream) and development, thereby potentially promoting reduced development resource consumption (e.g., in terms of costs, time to market, manpower, etc.), which again is a result of the addition of the quantization offset after audio decoding is performed.

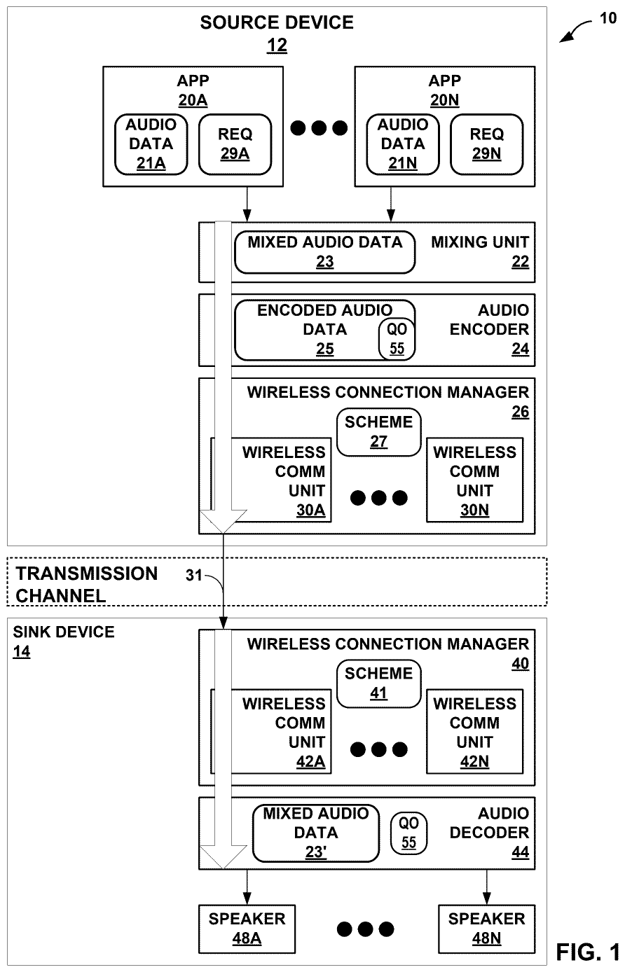

FIG. 1 is a diagram illustrating a system 10 that may perform various aspects of the techniques described in this disclosure for enabling codec agnostic lossless audio coding in accordance with various aspects of the techniques described in this disclosure. As shown in the example of FIG. 1, the system 10 includes a source device 12 and a sink device 14. Although described with respect to the source device 12 and the sink device 14, the source device 12 may operate, in some instances, as the sink device, and the sink device 14 may, in these and other instances, operate as the source device. As such, the example of system 10 shown in FIG. 1 is merely one example illustrative of various aspects of the techniques described in this disclosure.

In any event, the source device 12 may represent any form of computing device capable of implementing the techniques described in this disclosure, including a handset (or cellular phone), a tablet computer, a so-called smart phone, a remotely piloted aircraft (such as a so-called “drone”), a robot, a desktop computer, a receiver (such as an audio/visual—AV—receiver), a set-top box, a television (including so-called “smart televisions”), a media player (such as a digital video disc player, a streaming media player, a Blue-Ray Disc™ player, etc.), a virtual reality headset or other wearable headset (including smart glasses), a smart watch, or any other device capable of communicating audio data wirelessly to a sink device via a personal area network (PAN), a wireless network (e.g., a WiFi™), a network that conforms to the Institute of Electrical and Electronics Engineering (IEEE) 802.11 suite of protocols, and/or other wired or wireless network protocols. For purposes of illustration, the source device 12 is assumed to represent a smart phone.

The sink device 14 may represent any form of computing device capable of implementing the techniques described in this disclosure, including a handset (or cellular phone), a tablet computer, a smart phone, a smart watch, smart glasses or other wearable headset (including an extended reality headset), a desktop computer, a wireless headset (which may include wireless headphones that include or exclude a microphone, and so-called smart wireless headphones that include additional functionality such as fitness monitoring, on-board music storage and/or playback, dedicated cellular capabilities, etc.), a wireless speaker (including a so-called “smart speaker”), a watch (including so-called “smart watches”), or any other device capable of reproducing a soundfield based on audio data communicated wirelessly via the PAN and/or another wired or wireless network. Also, for purposes of illustration, the sink device 14 is assumed to represent wireless headphones.

As shown in the example of FIG. 1, the source device 12 includes one or more applications (“apps”) 20A-20N (“apps 20”), a mixing unit 22, an audio encoder 24, and a wireless connection manager 26. Although not shown in the example of FIG. 1, the source device 12 may include a number of other elements that support operation of apps 20, including an operating system, various hardware and/or software interfaces (such as user interfaces, including graphical user interfaces), one or more processors, memory, storage devices, and the like.

Each of the apps 20 represent software (such as a collection of instructions stored to a non-transitory computer readable media) that configure the system 10 to provide some functionality when executed by the one or more processors of the source device 12. The apps 20 may, to list a few examples, provide messaging functionality (such as access to emails, text messaging, and/or video messaging), voice calling functionality, video conferencing functionality, calendar functionality, audio streaming functionality, direction functionality, mapping functionality, gaming functionality (including streaming gaming functionality in which the game is executed on a different device, including a streaming game server executed in a cloud architecture), etc. Apps 20 may be first party applications designed and developed by the same company that designs and sells the operating system executed by the source device 12 (and often pre-installed on the source device 12) or third-party applications accessible via a so-called “app store” or possibly pre-installed on the source device 12. Each of the apps 20, when executed, may output audio data 21A-21N (“audio data 21”), respectively. In some examples, the audio data 21 may be generated from a microphone (not pictured) connected to the source device 12.

The mixing unit 22 represents a unit configured to mix one or more of audio data 21A-21N (“audio data 21”) output by the apps 20 (and other audio data output by the operating system—such as alerts or other tones, including keyboard press tones, ringtones, etc.) to generate mixed audio data 23. Audio mixing may refer to a process whereby multiple sounds (as set forth in the audio data 21) are combined into one or more channels. During mixing, the mixing unit 22 may also manipulate and/or enhance volume levels (which may also be referred to as “gain levels”), frequency content, and/or panoramic position of the audio data 21. In the context of streaming the audio data 21 over a wireless PAN session, the mixing unit 22 may output the mixed audio data 23 to the audio encoder 24.

The audio encoder 24 may represent a unit configured to encode the mixed audio data 23 and thereby obtain encoded audio data 25. In some examples, the audio encoder 24 may encode individual ones of the audio data 21. Referring for purposes of illustration to one example of the PAN protocols, Bluetooth® provides for a number of different types of audio codecs (which is a word resulting from combining the words “encoding” and “decoding”) and is extensible to include vendor specific audio codecs. The Advanced Audio Distribution Profile (A2DP) of Bluetooth® indicates that support for A2DP requires supporting a subband codec specified in A2DP. A2DP also supports codecs set forth in MPEG-1 Part 3 (MP2), MPEG-2 Part 3 (MP3), MPEG-2 Part 7 (advanced audio coding—AAC), MPEG-4 Part 3 (high efficiency-AAC—HE-AAC), and Adaptive Transform Acoustic Coding (ATRAC). Furthermore, as noted above, A2DP of Bluetooth® supports vendor specific codecs, such as aptX™ and various other versions of aptX (e.g., enhanced aptX—E-aptX, aptX live, and aptX high definition—aptX-HD).

The audio encoder 24 may operate consistent with one or more of any of the above listed audio codecs, as well as, audio codecs not listed above, but that operate to encode the mixed audio data 23 to obtain the encoded audio data 25. The audio encoder 24 may output the encoded audio data 25 to one of the wireless communication units 30A-30N (e.g., the wireless communication unit 30A, collectively “wireless communication units 30”) managed by the wireless connection manager 26. As described in more detail below, the audio encoder 24 may be configured to encode the audio data 21 and/or the mixed audio data 23 using one or more quantization offsets that are applied after audio encoding is performed to enable so-called lossless audio encoding.

The wireless connection manager 26 may represent a unit configured to allocate bandwidth within certain frequencies of the available spectrum to the different ones of the wireless communication units 30. For example, the Bluetooth® communication protocols operate over within the 2.5 GHz range of the spectrum, which overlaps with the range of the spectrum used by various WLAN communication protocols. The wireless connection manager 26 may allocate some portion of the bandwidth during a given time to the Bluetooth® protocol and different portions of the bandwidth during a different time to the overlapping WLAN protocols. The allocation of bandwidth and other is defined by a scheme 27. The wireless connection manager 40 may expose various application programmer interfaces (APIs) by which to adjust the allocation of bandwidth and other aspects of the communication protocols so as to achieve a specified quality of service (QoS). That is, the wireless connection manager 40 may provide the API to adjust the scheme 27 by which to control operation of the wireless communication units 30 to achieve the specified QoS. The QoS may be adaptable to provide for scalable audio coding in which the bitrate of the bitstream 31 changes (often within some time threshold, such as 20 milliseconds—ms) between a low bitrate (e.g., equal to or less than 82 Kbps) and a relatively higher bitrate (e.g., one or more Mbps).

In other words, the wireless connection manager 26 may manage coexistence of multiple wireless communication units 30 that operate within the same spectrum, such as certain WLAN communication protocols and some PAN protocols as discussed above. The wireless connection manager 26 may include a coexistence scheme 27 (shown in FIG. 1 as “scheme 27”) that indicates when (e.g., an interval) and how many packets each of the wireless communication units 30 may send, the size of the packets sent, and the like.

The wireless communication units 30 may each represent a wireless communication unit 30 that operates in accordance with one or more communication protocols to communicate encoded audio data 25 via a transmission channel to the sink device 14. In the example of FIG. 1, the wireless communication unit 30A is assumed for purposes of illustration to operate in accordance with the Bluetooth® suite of communication protocols. It is further assumed that the wireless communication unit 30A operates in accordance with A2DP to establish a PAN link (over the transmission channel) to allow for delivery of the encoded audio data 25 from the source device 12 to the sink device 14.

More information concerning the Bluetooth® suite of communication protocols can be found in a document entitled “Bluetooth Core Specification v 5.0,” published Dec. 6, 2016, and available at: www.bluetooth.org/en-us/specification/adopted-specifications. More information concerning A2DP can be found in a document entitled “Advanced Audio Distribution Profile Specification,” version 1.3.1, published on Jul. 14, 2015.

The wireless communication unit 30A may output the encoded audio data 25 as the bitstream 31 to the sink device 14 via a transmission channel, which may be a wired or wireless channel, a data storage device, or the like. While shown in FIG. 1 as being directly transmitted to the sink device 14, the source device 12 may output the bitstream 31 to an intermediate device positioned between the source device 12 and the sink device 14. The intermediate device may store the bitstream 31 for later delivery to the sink device 14, which may request the bitstream 31. The intermediate device may comprise a file server, a web server, a desktop computer, a laptop computer, a tablet computer, a mobile phone, a smart phone, a smart watch, smart glasses, a head mounted display (e.g., a virtual reality headset, an extended reality headset, an augmented reality headset, and the like) or any other device capable of storing the bitstream 31 for later retrieval by an audio decoder. This intermediate device may reside in a content delivery network capable of streaming the bitstream 31 (and possibly in conjunction with transmitting a corresponding video data bitstream) to subscribers, such as the sink device 14, requesting the bitstream 31.

Alternatively, the source device 12 may store the bitstream 31 to a storage medium, such as a compact disc, a digital video disc, a high definition video disc or other storage media, most of which are capable of being read by a computer and therefore may be referred to as computer-readable storage media or non-transitory computer-readable storage media. In this context, the transmission channel may refer to those channels by which content stored to these mediums are transmitted (and may include retail stores and other store-based delivery mechanism). In any event, the techniques of this disclosure should not therefore be limited in this respect to the example of FIG. 1.

As further shown in the example of FIG. 1, the sink device 14 includes a wireless connection manager 40 that manages one or more of wireless communication units 42A-42N (“wireless communication units 42”) according to a scheme 41, an audio decoder 44, and one or more speakers 48A-48N (“speakers 48”). The wireless connection manager 40 may operate in a manner similar to that described above with respect to the wireless connection manager 26, exposing an API to adjust the scheme 41 by which operation of the wireless communication units 42 achieve a specified QoS.

The wireless communication units 42 may be similar in operation to the wireless communication units 30, except that the wireless communication units 42 operate reciprocally to the wireless communication units 30 to decapsulate the encoded audio data 25. One of the wireless communication units 42 (e.g., the wireless communication unit 42A) is assumed to operate in accordance with the Bluetooth® suite of communication protocols and reciprocal to the wireless communication protocol 28A. The wireless communication unit 42A may output the encoded audio data 25 to the audio decoder 44.

The audio decoder 44 may operate in a manner that is reciprocal to the audio encoder 24. The audio decoder 44 may operate consistent with one or more of any of the above listed audio codecs, as well as, audio codecs not listed above, but that operate to decode the encoded audio data 25 to obtain mixed audio data 23′. The prime designation with respect to “mixed audio data 23” denotes that there may be some loss due to quantization or other lossy operations that occur during encoding by the audio encoder 24. The audio decoder 44 may render and output the mixed audio data 23′ to one or more of the speakers 48. The audio decoder 44 may render the mixed audio data 23′ to speaker feeds, which are then used to drive the speakers 48. The speakers 48 may represent any form of transducer that reproduces a soundfield based on the speaker feeds, where the transducer may represent ear buds, headphones, loudspeakers, and the like in any form, including bone transducing headphones, planar magnetic headphones, in-ear monitors, etc.

Each of the speakers 48 represent a transducer configured to reproduce a soundfield from the mixed audio data 23′. The transducer may be integrated within the sink device 14 as shown in the example of FIG. 1 or may be communicatively coupled to the sink device 14 (via a wire or wirelessly). The speakers 48 may represent any form of speaker, such as a loudspeaker, a headphone speaker, or a speaker in an earbud. Furthermore, although described with respect to a transducer, the speakers 48 may represent other forms of speakers, such as the “speakers” used in bone conducting headphones that send vibrations to the upper jaw, which induces sound in the human aural system.

As noted above, the apps 20 may output audio data 21 to the mixing unit 22. Prior to outputting the audio data 21, the apps 20 may interface with the operating system to initialize an audio processing path for output via integrated speakers (not shown in the example of FIG. 1) or a physical connection (such as a mini-stereo audio jack, which is also known as 3.5 millimeter—mm—minijack, a universal system bus version C—USB-C port, etc.). As such, the audio processing path may be referred to as a wired audio processing path considering that the integrated speaker is connected by a wired connection similar to that provided by the physical connection via the mini-stereo audio jack. The wired audio processing path may represent hardware or a combination of hardware and software that processes the audio data 21 to achieve a target quality of service (QoS), which may specify a signal-to-noise-ratio (SNR) to achieve a target bitrate and provide a total harmonic distortion plus noise (THD+N).

To illustrate, one of the apps 20 (which is assumed to be the app 20A for purposes of illustration) may issue, when initializing or reinitializing the wired audio processing path, one or more requests 29A-29N (“requests 2(”) for a particular QoS for the audio data 21A output by the app 20A. The request 29A may specify, as a couple of examples, a high latency (that results in high quality) wired audio processing path, a low latency (that may result in lower quality) wired audio processing path, or some intermediate latency wired audio processing path. The high latency wired audio processing path may also be referred to as a high quality wired audio processing path, while the low latency wired audio processing path may also be referred to as a low quality wired audio processing path.

In addition, the request 29A may specify a high quality wireless audio processing path, a low quality wireless audio processing path, and some intermediate quality processing path. The apps 20 may dynamically adapt the audio processing path to accommodate switching between various audio processing paths, such as is common in gaming instances in which the user switches between a wireless audio processing path (e.g., using a PAN) and a wired audio processing path. Whether a high latency, low latency, or intermediate latency is selected for either a wired or wireless audio processing path, the app 20A may issue the request 29A to dynamically adapt audio processing to accommodate the user preference, where typically such dynamic adaptation of the audio processing path is configured to be performed within some time threshold (e.g., seven milliseconds—ms, 20 ms, etc.).

As such, the audio encoder 24 may perform scalable audio encoding to dynamically transition encoding to accommodate the different audio processing paths, where high latency, low quality audio processing is performed for bandwidth limited transmission channels (as is common via PAN connections) and low latency, high quality audio processing is performed for relatively higher bandwidth transmission channels (as is common via wired connections). As one example, the app 20A may represent a gaming application 20A (and may be referred to as “gaming app 20A”), and the user may switch between a PAN transmission channel and a wired or (wireless, but wide area network—WAN—connection) having a higher bandwidth compared to the PAN transmission channel. In these instances, the audio encoder 24 may transition the audio encoding between a lower and higher bitrate to satisfy the requirements of the different transmission channels (e.g., PAN versus WAN and/or wired).

In instances where scalable audio coding is required in which bitrates may fluctuate between a relatively lower bitrate and a higher bitrate (e.g., from 80 Kilobits per second—Kbps—to one or more Megabits per second—Mbps), audio processing complexity may increase (in terms of processing cycles performed, memory bus bandwidth, and associated power consumption). As such, scalable audio coding algorithms may be too demanding in terms of computing resources (such as processor complexity, memory bus bandwidth, memory consumption, etc. along with corresponding power) to accommodate implementation in limited computing resource applications that may be encountered for PAN implementations.

In addition, there is growing end user interest in and/or end user demand for lossless audio coding (where coding refers to either or both of encoding and decoding), which may result in improved reproduction of the original audio data as lossless audio encoding may ensure bit exactness (between the original audio data, e.g., the mixed audio data 23, and the decoded audio data, e.g., the mixed audio data 23′) within a tolerable level (e.g., one-bit, two-bit, etc. differences per corresponding samples of the mixed audio data 23 and the mixed audio data 23′). However, to ensure bit exactness, lossless audio codecs are often implemented using fixed-point implementations that are difficult to develop and validate in a manner that ensures bit exactness within the tolerable level compared to floating-point implementations.

Further, these fixed implementations of lossless audio codecs may be unable to easily accommodate error correction (to account for dropped packets during transmission), scalability (to account for reduced bandwidth during transmission), low latency reproduction (to account for high latency transmission links whether due to network congestion, low power transmission, etc.), adaptability (in terms of ensuring varying levels of bit exactness), and the like. As such, many lossless audio codecs rely on higher bandwidth connections (e.g., provided via wireless network protocols, such as the Institute of Electrical and Electronics Engineers—IEEE—802.11 suite of protocols, which may be referred to as WiFi™) that can support larger packet sizes and provide higher throughput to enable latency sensitive applications to obtain bit exact versions of mixed audio data 23′ within a tolerable level and within a desired latency limit.

In accordance with various aspects of the techniques described in this disclosure, The audio encoder 24 may perform lossless audio encoding that leverages existing lossy or lossless audio codecs (where again the term “codecs” may refer to the combination of the audio encoder and the reciprocal audio decoder), layering a so-called quantization offset (QO) 55 on top of the audio codecs to facilitate bit exactness within a tolerable level (e.g., a set number of bit differences between the original audio data, such as mixed audio data 23, and the decoded audio data, such as mixed audio data 23′, decoded from the encoded audio bitstream 31). The audio encoder 24 may specify the quantization offset in the encoded audio bitstream 31 such that the audio decoder 44 may adapt or otherwise adjust the mixed audio data 23′ to obtain adjusted audio data that is within the tolerable level of bit exactness.

In operation, the audio encoder 24 may implement an existing or new lossy or lossless audio encoder (along with a partial or full audio decoder in order to potentially reproduce what audio decoder 44 obtains from the encoded audio data 25). The audio encoder 24 may utilize the existing or new lossy or lossless audio encoder to remove or reduce correlation between aspects (e.g., different channels) of mixed audio data 23 (removing redundant aspects of mixed audio data 23). The audio encoder 24 may next decode the encoded audio data 25. It should be noted that mixed audio data 23 includes one or more samples (generally arranged in terms of linear time order), where the encoded audio data 25 may include a corresponding one or more samples. The audio encoder 24 may encode each sample of the mixed audio data 23 and then decode each corresponding sample of the encoded audio data 25 to obtain corresponding decoded audio data (which may be referred to as the mixed audio data 23′).

The audio encoder 24 may next obtain, based on the mixed audio data 23 and the mixed audio data 23′, a quantization offset (QO) 55. In some examples, the audio encoder 24 may obtain, based on the mixed audio data 23 and the mixed audio data 23′, and for each sample of mixed audio data 23′, a corresponding one of QOs 55. Depending on the tolerable level of bit exactness (which may be developer defined, dynamically determined, etc.), the audio encoder 24 may utilize one or more bits to define QO 55. For example, when the tolerable level of bit exactness is a single bit difference between each sample of mixed audio data 23 and the corresponding sample of the mixed audio data 23′, the audio encoder 24 may utilize two bits to define each of QOs 55 as either a positive one, a zero, or a negative one (where two bits are required to identify these three different states).

To obtain the QO 55 for any given sample of mixed audio data 23′, the audio encoder 24 may apply a baseline offset (defined to accommodate the tolerable level of bit exactness) to a sample of the mixed audio data 23 to which the QO 55 corresponds to obtain an adjusted sample. The audio encoder 24 may next obtain, based on a difference between the sample of the mixed audio data 23 and a corresponding sample of the mixed audio data 23′, the QO 55. The QO 55 may effectively be used to reduce boundary errors in which bits in the sample of the mixed audio data 23 that are close to a power of two may result in large bit differences between the sample of the mixed audio data 23 and the corresponding sample of the mixed audio data 23′ that may be introduced due to differences in implementations (e.g., due to rounding algorithm differences, and other mathematical operations, such as an FFT, MDCT, etc.).

For example, differences in implementations may result in an example sample of the mixed audio data 23 having a value of 0x000C, being decoded to the corresponding sample of the mixed audio data 23′ having a value of 0x000F. In this example, the bit difference between 0x000C and 0x000F is two. As such, the audio encoder 24 may obtain the QO 55 that represents a value of negative one, thereby reducing the bit difference to be one bit that satisfies the tolerable level of bit exactness. The audio encoder 24 may also determine, based on the adjusted sample (resulting from applying the baseline offset to the sample of the mixed audio data 23) and the sample of the mixed audio data 23, residual data.

Returning to the above example, the audio encoder 24 may subtract the adjusted sample from the sample of the mixed audio data 23 to obtain the residual data. Assuming the baseline offset has a value of two (0x2), the audio encoder 24 may determine the residual data as the adjusted sample (having a value of 0x000C plus 0x2, which equals 0x000E) subtracted from the sample of the mixed audio data 23 (having a value of 0x000C), where 0x000C minus 0x000E equals negative two (−2). The audio encoder 24 may specify the QO 55 (and possibly the residual data) in encoded audio data 25 (which forms the basis for the encoded audio bitstream 31). The audio encoder 24 may, as noted above, output the encoded audio bitstream 31 to, in the example of FIG. 1, the sink device 14.

The sink device 14 may obtain the encoded audio bitstream 31 representative of the mixed audio data 23, and invoke the audio decoder 44 that operates reciprocally to the audio encoder 24 to decode the encoded audio bitstream 31 to obtain decoded audio data (represented by the mixed audio data 23′). The audio decoder 44 may also obtain, from the encoded audio bitstream 31, the QO 55 for one or more samples of the mixed audio data 23′. Next, the audio decoder 44 may apply the QO 55 to the mixed audio data 23′ to obtain corrected audio data. As noted above, the QO 55 may correct for any bit differences between the mixed audio data 23 that was encoded to obtain the encoded audio bitstream 31 and the mixed audio data 23′, effectively reproducing the mixed audio data 23 with bit exactness within the tolerable level.

To apply the QO 55, the audio decoder 44 may apply the baseline offset to a sample of the mixed audio data 23′ to which the QO 55 corresponds to obtain the adjusted sample. Returning to the example that was used to illustrate operation of the audio encoder 24, and assuming that the baseline offset is implicitly obtained by the audio decoder 44 (e.g., the baseline offset is statically defined, dynamically determined based on a state of the encoded audio bitstream 31, such as a specified audio bitrate, sampling period, Quality of Service, packet size, etc., dynamically determined based on a state of the transmission channel, such as a latency, a signal to noise ratio, a packet resend rate, a dropped packet rate, etc., and the like), the audio decoder 44 may determine the baseline offset as 0x2. The audio decoder 44 may obtain the sample of the mixed audio data 23′ that has a value, as one example, of 0.0010, and the QO 55 having a value indicative of negative one (0x3). The audio decoder 44 may apply the baseline offset (0x2) by adding the baseline offset to the sample of the mixed audio data 23′ to obtain an adjusted sample.

The audio decoder 44 may then apply the quantization offset to the adjusted sample to obtain an offset sample. In the above example, the audio decoder 44 may subtract the quantization offset having a value indicative of negative one (0x3) from the adjusted sample (0x0010 plus 0x2 equals 0x0012), which results in an offset value having a value of (0x0012 minus 0x3, which equals 0x000F). The audio decoder 44 may apply a bitmask (which again may be implicitly obtained similar to the baseline offset) to one or more bits of the offset sample to obtain a masked sample. In the example discussed above, it is assumed that the bitmask has a value of 0x3, where the audio decoder 44 applies the bitmask to the last two bits of the offset sample using a bitwise AND operation after bitwise inverting the bitmask (0x03 is inverted to become 0xC), and therefore obtains a masked sample having a value of 0x000C.

The audio decoder 44 may then reapply the baseline offset to the masked sample to obtain a readjusted sample. In the ongoing example, the audio decoder 44 may add the baseline offset having a value of 0x2 to the masked sample having a value of 0x000C to obtain a readjusted sample having a value of 0x000E. The audio decoder 44 may then obtain, based on the residual data specified in the encoded audio bitstream 31 and the readjusted sample, a bit accurate sample of the mixed audio data 23′. The audio decoder 44 may, returning to the ongoing example, add the residual of negative two (−2) to the readjusted sample having a value of 0x000E to obtain a bit accurate sample of the mixed audio data 23′ having a value of 0x000C (as 0x000E plus negative two equals 0x000C), which is a bit accurate value that is similar (meaning within the tolerable level of bit exactness) or possibly the same as it is in this example.

In this way, various aspects of the techniques may allow for lossless audio coding regardless of the underlying audio codec that is used to remove or reduce any correlation within the original audio data. That is, given that the quantization offset 55 is applied after fully decoding the encoded audio bitstream 31, the various aspects of the techniques described in this disclosure may be agnostic to the underlying audio codec, thereby allowing rapid development of lossless audio codecs as existing lossy or lossless codecs may be employed, thereby reducing development costs, time to market, etc. Further, the lossless audio codec enabled by way of the techniques described in this disclosure may allow for the addition of error correction, scalability (in terms of bandwidth consumption), and adaptability (in terms of providing quantization offsets that achieve varying levels of bit exactness) as a result of applying the quantization offset after the existing audio decoder performs audio decoding with respect to the audio encoded bitstream. In this way, the lossless audio codec may accommodate both transmission link resiliency and latency demands.

Moreover, the lossless audio codec enabled by various aspects of the techniques described in this disclosure may allow for varying differences in the underlying hardware architecture that may inject errors. For example, processing circuitry that implements the lossless audio encoder 24 may perform rounding and/or other mathematical operations (such as a fast Fourier transform—FFT, a modified discrete cosine transform—DCT, etc.) in a manner that differs from processing circuitry that implements that lossless audio decoder 44, resulting in potential difficulties to ensure bit exactness within the tolerable level. In addition, the implementation of the lossless audio encoder 24 may differ slightly from the implementation of the lossless audio decoder 44 that results in difficulties ensuring bit exactness within the tolerable level.

The lossless audio codec enabled by way of the techniques described herein may overcome these difficulties with relatively minor bit overhead (e.g., in terms of specifying the quantization offset 55 in the encoded audio bitstream) and development, thereby potentially promoting reduced development resource consumption (e.g., in terms of costs, time to market, manpower, etc.), which again is a result of the addition of the quantization offset 55 after audio decoding is performed.

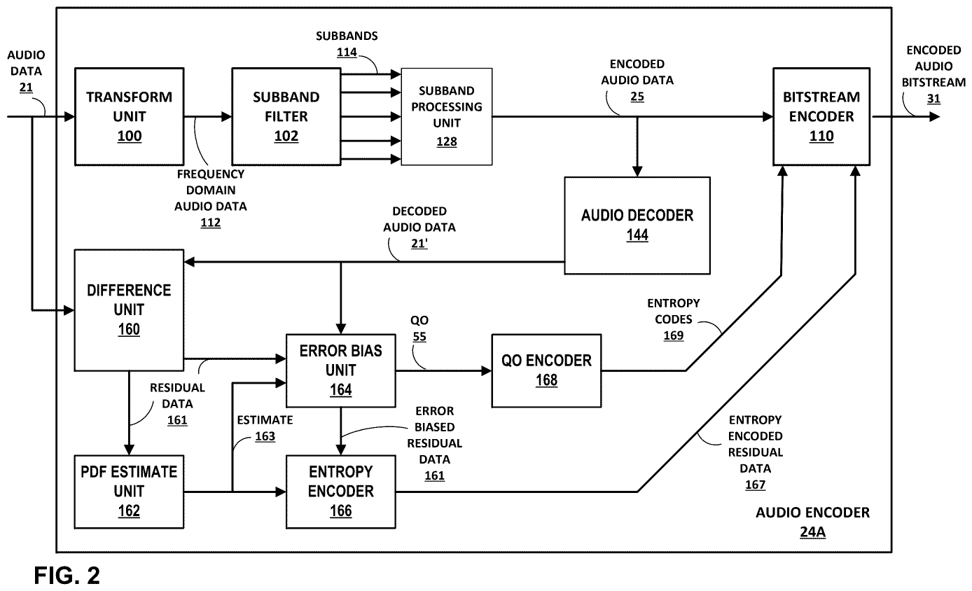

FIG. 2 is a block diagram illustrating an example of the audio encoder 24 configured to perform various aspects of the lossless audio encoding techniques described in this disclosure. The audio encoder 24A may represent audio encoder 24 shown in FIG. 1 and may be configured to encode audio data for transmission over a PAN (e.g., Bluetooth®). However, the techniques of this disclosure performed by the audio encoder 24 may be used in any context where the compression of audio data is desired. In some examples, the audio encoder 24A may be configured to encode the audio data 21 in accordance with as aptX™ audio codec, including, e.g., enhanced aptX—E-aptX, aptX live, and aptX high definition.

In the example of FIG. 2, the audio encoder 24A may be configured to encode the audio data 21 (or the mixed audio data 23) using any newly developed or existing audio codec, such as an audio codec that applies a transform represented by a transform unit 100, a subband filter 102, and a subband processing unit 128 as discussed in further detail below.

The audio data 21 may be sampled at a particular sampling frequency. Example sampling frequencies may include 48 kHz or 44.1 kHz, though any desired sampling frequency may be used. Each digital sample of the audio data 21 may be defined by a particular input bit depth, e.g., 16 bits or 24 bits. In one example, the audio encoder 24A may be configured to operate on a single channel of the audio data 21 (e.g., mono audio). In another example, the audio encoder 24A may be configured to independently encode two or more channels of the audio data 21. For example, the audio data 21 may include left and right channels for stereo audio. In this example, the audio encoder 24A may be configured to encode the left and right audio channels independently in a dual mono mode. In other examples, the audio encoder 24A may be configured to encode two or more channels of the audio data 21 together (e.g., in a joint stereo mode). For example, the audio encoder 24A may perform certain compression operations by predicting one channel of the audio data 21 from another channel of the audio data 21.

Regardless of how the channels of the audio data 21 are arranged, the audio encoder 24A obtains the audio data 21 and sends that audio data 21 to the transform unit 100. The transform unit 100 is configured to transform a frame of the audio data 21 from the time domain to the frequency domain to produce frequency domain audio data 112. A frame of the audio data 21 may be represented by a predetermined number of samples of the audio data. In one example, a frame of the audio data 21 may be 1024 samples wide. Different frame widths may be chosen based on the frequency transform being used and the amount of compression desired. The frequency domain audio data 112 may be represented as transform coefficients, where the value of each of the transform coefficients represents an energy of the frequency domain audio data 112 at a particular frequency.

In one example, the transform unit 100 may be configured to transform the audio data 21 into the frequency domain audio data 112 using a modified discrete cosine transform (MDCT). An MDCT is a “lapped” transform that is based on a type-IV discrete cosine transform. The MDCT is considered “lapped” as it works on data from multiple frames. That is, in order to perform the transform using an MDCT, transform unit 100 may include a fifty percent overlap window into a subsequent frame of audio data. The overlapped nature of an MDCT may be useful for data compression techniques, such as audio encoding, as it may reduce artifacts from coding at frame boundaries. The transform unit 100 need not be constrained to using an MDCT but may use other frequency domain transformation techniques for transforming the audio data 21 into the frequency domain audio data 112.

A subband filter 102 separates the frequency domain audio data 112 into subbands 114. Each of the subbands 114 includes transform coefficients of the frequency domain audio data 112 in a particular frequency range. For instance, the subband filter 102 may separate the frequency domain audio data 112 into twenty different subbands. In some examples, subband filter 102 may be configured to separate the frequency domain audio data 112 into subbands 114 of uniform frequency ranges. In other examples, subband filter 102 may be configured to separate the frequency domain audio data 112 into subbands 114 of non-uniform frequency ranges.

For example, subband filter 102 may be configured to separate the frequency domain audio data 112 into subbands 114 according to the Bark scale. In general, the subbands of a Bark scale have frequency ranges that are perceptually equal distances. That is, the subbands of the Bark scale are not equal in terms of frequency range, but rather, are equal in terms of human aural perception. In general, subbands at the lower frequencies will have fewer transform coefficients, as lower frequencies are easier to perceive by the human aural system. As such, the frequency domain audio data 112 in lower frequency subbands of the subbands 114 is less compressed by the audio encoder 24A, as compared to higher frequency subbands. Likewise, higher frequency subbands of the subbands 114 may include more transform coefficients, as higher frequencies are harder to perceive by the human aural system. As such, the frequency domain audio data 112 in higher frequency subbands of the subbands 114 may be more compressed by the audio encoder 24A, as compared to lower frequency subbands.

The audio encoder 24A may be configured to process each of subbands 114 using a subband processing unit 128. That is, the subband processing unit 128 may be configured to process each of subbands separately, and output encoded audio data 25 to a bitstream encoder 110 that may generate the encoded audio bitstream 31 based on the encoded audio data 25.

As further shown in the example of FIG. 2, the audio encoder 24A may include an audio decoder 144 (which represents a full or partial version of the audio decoder 44 shown in the example of FIG. 1), a difference unit 160, a probability density function (PDF) estimate unit 162, an error bias unit 164, an entropy encoder 166, and a QO encoder 168. The audio encoder 24A may invoke the audio decoder 144 to decode the encoded audio data 25 (in a reciprocal fashion to that described above with respect to the audio encoder 24A) and obtain decoded audio data 21′, outputting the decoded audio data 21′ to the difference unit 160.

The difference unit 160 may represent a unit configured to calculate a difference between the audio data 21 and the decoded audio data 21′. The difference unit 160 may determine residual data 161 based on the difference between the audio data 21 and the decoded audio data 21′. The residual data 161 may be used to ensure lossless audio coding, as the residual data 161 may be used to restore the original audio data 21 with bit exactness to the tolerable level of bit differences. The difference unit 160 may determine, based on the adjusted sample (resulting from applying the baseline offset to the sample of the mixed audio data 23) and the sample of the mixed audio data 23, the residual data 161.

To obtain the difference, the difference unit 160 may apply a baseline offset (defined to accommodate the tolerable level of bit exactness) to a sample of the audio data 21 to which the QO 55 corresponds to obtain an adjusted sample. The error bias unit 164 may next obtain, based on a difference between the sample of the audio data 21 and the corresponding adjusted sample of the decoded audio data 21′, the residual data 161. The difference unit 160 may output the residual data 161 to the PDF estimate unit 162 and the error bias unit 164.

The PDF estimate unit 162 may estimate the PDF of the residual data 161, where the estimate may allow four bits (or some other number of bits) for a difference of 16 to be corrected because of a binary encoding scheme uses a form of entropy encoding (e.g., Golomb-Rice encoding) in which the 4 most significant bits of a wider binary word are encoded. This may result in additional headroom over simply encoding QO to only correct for a precision error of, in various examples, one bit. The PDF estimate unit 162 may output an estimate 163 to the error bias unit 164 and the entropy encoder 166.

The error bias unit 164 may represent a unit configured to bias the error (due to bits specifying a value near to or equal to a power of two) of the residual data 161 according to various aspects of the techniques described in this disclosure. In other words, the error bias unit 165 may bias the residual data 161 away from boundaries existing at powers of two by determining the QO 55 in a manner that either adds or subtracts a value (defined by one or more bits). The error bias unit 164 may output the QO 55 to QO encoder 168. Although described with respect to binary systems, a similar error biasing process may be employed in other systems that are not based on binary values.

The error bias unit 164 may also determine the difference between the adjusted sample of the decoded audio data 21′ and the corresponding sample of the audio data 21, where the difference represents error biased residual data 161. The error bias unit 164 may output the error biased residual data 161 to entropy encoder 166, which entropy encodes the error biased residual data 161 to obtain entropy encoded residual data 167. The bitstream encoder 110 may update the encoded audio bitstream 31 to include the entropy encoded residual data 167.

That is, the entropy encoder 166 may perform any form of entropy encoding with respect to the error biased residual data 161, such as Golomb-Rice encoding, Huffman encoding, arithmetic encoding, etc. Assuming Golomb-Rice encoding is performed for purposes of example, the entropy encoder 166 may perform Golomb-Rice encoding with respect to the top four bits of each sample of the error biased residual data 161 as the lower eight bits tend to be mostly noise (which does not benefit much from entropy encoding). Golomb-Rice encoding may include determining the mean value to select the size of the quotient and remainder, which are then binary encoded.

To ensure packets are generated at fixed intervals, a minimum size for the remainder is set. The entropy encoder 166 may then scale the error code to fit the remainder, allowing the entropy encoder 166 to achieve 8 bits of error encoding for 1.6 bits (3.2 bits for each pair of values). If the remainder exceeds 8 bits, the error encoding is adjusted to utilize the additional space.

The QO encoder 168 may obtain the QO 55 (as a signed integer value) and encode the QO 55. The QO encoder 168 may encode one (or more) of the QOs 55 (when determined for each sample) using a signaling mechanism. For example, the QO encoder 168 may specify two, two-bit QO values for two QOs 55 as a single 3-bit value to achieve bit exactness within a tolerable level of difference (e.g., a 1-bit difference level). To illustrate, consider the following example table that allows 3-bits to specify two QOs 55 (each identifying three states of positive one, zero, and negative one).

| Code | Even (QO) | Odd (QO) |
|---|---|---|
| 0000b | 0 | 0 |
| 001b | 0 | −1 |
| 010b | 0 | +1 |
| 011b | −1 | 0 |
| 100b | −1 | −1 |
| 101b | −1 | +1 |
| 110b | +1 | 0 |
| 111b | +1 | −1 |
| 0111b | +1 | +1 |

These codes may represent entropy codes that may achieve an average of 3.2 bits (where the 0.2 in additional bits reflects that some of the codes are four bits, while some of the codes are three bits). The QO encoder 168 may output entropy codes 169 to the bitstream encoder 110, which may specify the entropy codes 169 to the encoded audio bitstream 31.

In other words, QO encoder 168 may perform entropy encoding with respect to the QO 55 to obtain an entropy coded version of the QO 55 (e.g., entropy codes 169).

In some instances, QO encoder 168 may, as noted above, perform entropy encoding with respect to a combination of one or more of the QOs 55 (e.g., a first QO and a second QO of the QOs 55) to obtain an entropy encoded version of the combination of the one or more of the QOs 55. In either instance, QO encoder 168 passes entropy codes 169 representative of an entropy encoded version of one or more QOs 55 to bitstream encoder 110, which specifies the entropy codes 169 in the encoded audio bitstream 31.

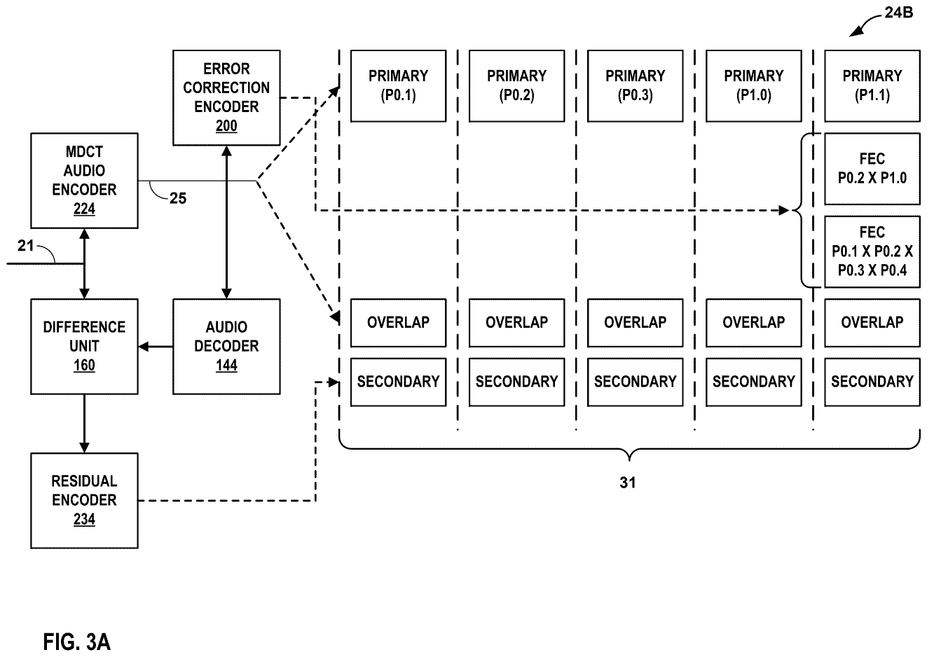

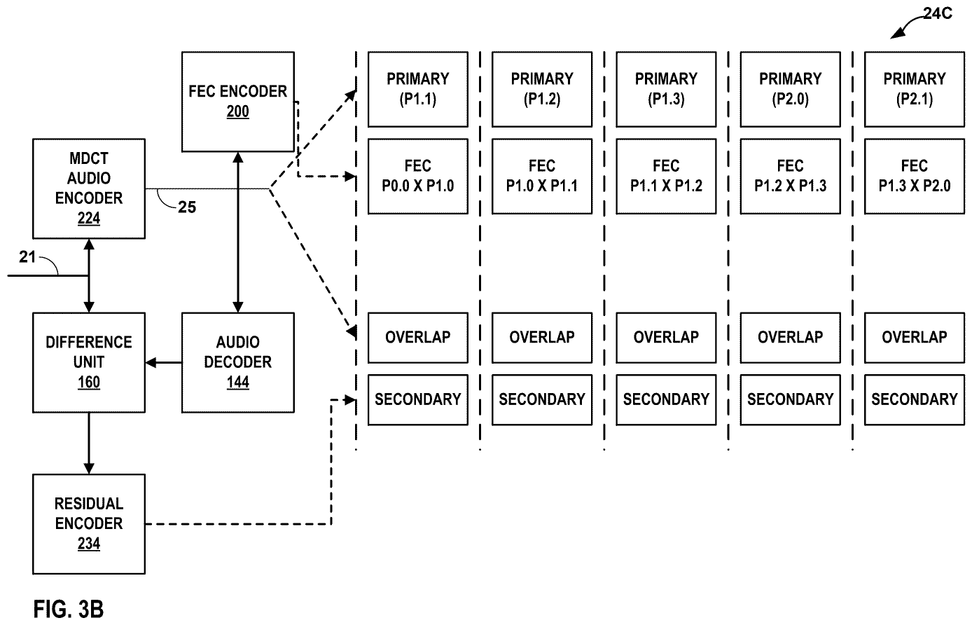

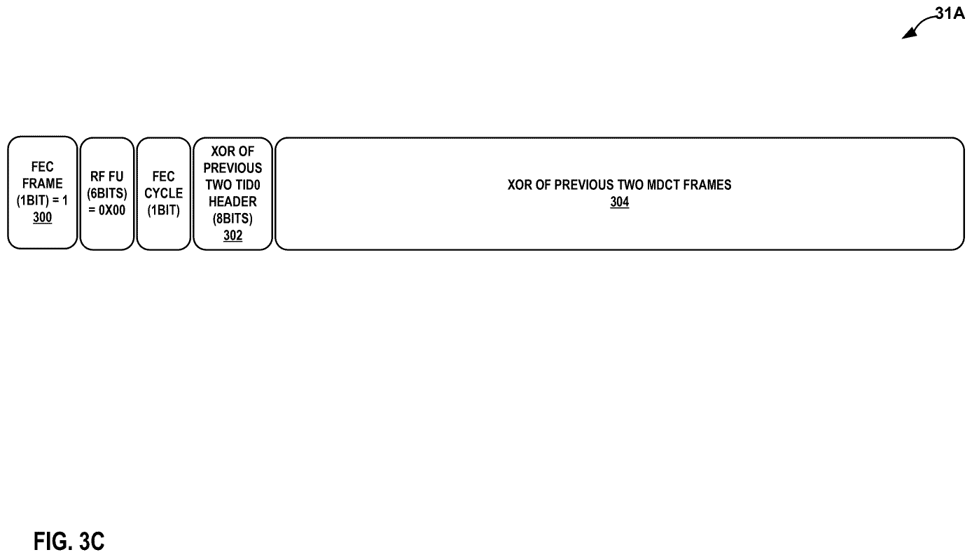

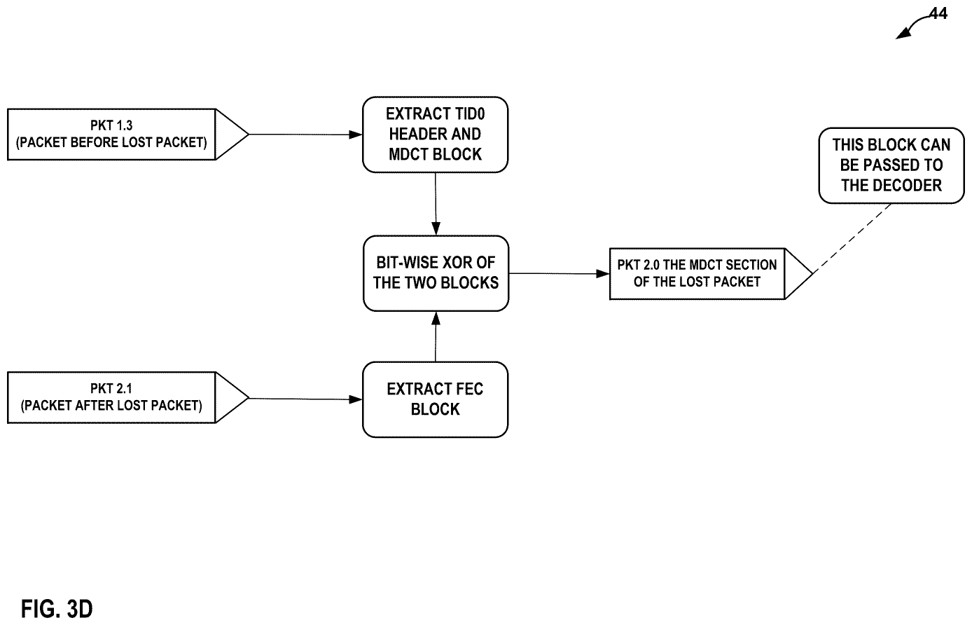

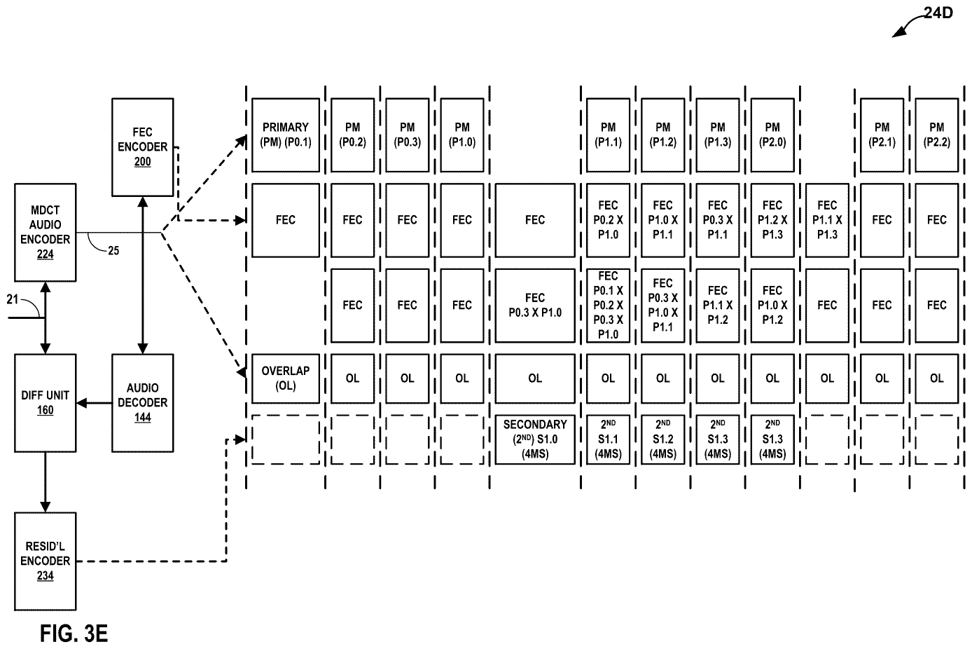

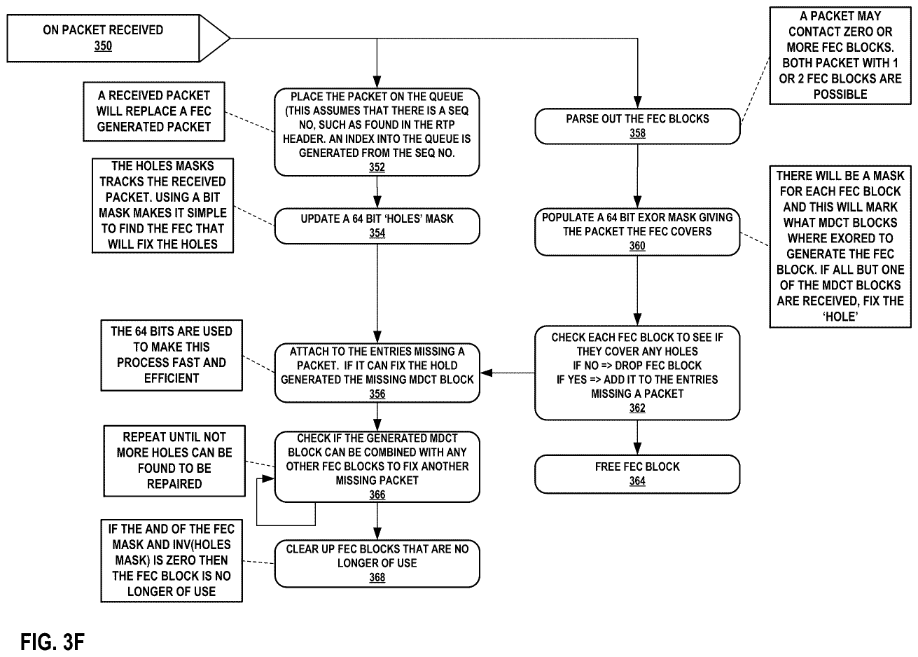

FIG. 3A-3F are block diagrams illustrating examples of an audio encoder that includes error correction in accordance with various aspects of the techniques described in this disclosure. As shown in the example of FIG. 3A, an audio encoder 24B includes an MDCT audio encoder 224, the difference unit 160, the audio decoder 144, and a residual encoder 234. The MDCT audio encoder 224 may represent or otherwise include the transform unit 100, the subband filter 102, and the subband processing unit 128 described above with respect to the example of FIG. 2, which operate as described above to produce encoded audio data 25.

The audio encoder 24B outputs the encoded audio data to the audio decoder 144 (which is also described in more detail above with respect to the example of FIG. 2), which performs reciprocal audio decoding with respect to the encoded audio data 25 to obtain decoded audio data 21′. The audio decoder 144 may pass the decoded audio data 21′ to the difference unit 160.

The difference unit 160 may also obtain the audio data 21 and compute a difference between samples of the audio data 21 and the corresponding samples of the decoded audio data 21′ to obtain residual data 161. The difference unit 160 may output the residual data 161 to the residual encoder 234. The residual encoder 234 may represent or otherwise include the PDF estimate unit 162, the error bias unit 164, the entropy encoder 166, and the QO encoder 168 (each of which is described above in more detail with respect to the example of FIG. 2).

The error correction encoder 200 may be integrated nearly seamlessly into the audio encoder 24B while still maintaining lossless audio encoding as a result, again, of performing residual encoding after each sample of the audio data 21 is already encoded (and not during encoding of each sample itself). Error correction encoder 200 may receive the encoded audio data 25 and obtain, for a first sample (or a collection of samples for a packet denoted “Primary (P1.1)”) of the encoded audio bitstream 31 subsequent to a second sample (or a collection of samples for packets denoted “Primary (P0.1),” “Primary (P0.2),” “Primary (P0.3),” and “Primary (P1.0)”) in the encoded audio bitstream 31, error correction data used to perform error correction with respect to the second sample of the encoded audio bitstream 31. The error correction encoder 200 may obtain the error correction data as a logical exclusive OR operation (that may be denoted as “XOR” and/or “EXOR”), which refers to a bit-wise comparison of the first sample of the audio data 21 and another sample of the audio data 21 (e.g., a subsequent sample from the first sample of the audio data 21).

As noted above, the error correction encoder 200 may perform forward error correction (FEC), and the error correction data is shown in the example of FIG. 3A as “FEC P0.2×P1.0” and “FEC P0.1×P0.2×P0.3×P0.4.” In other words, FEC P0.2×P1.0 indicates that error correction data is provided for Primary (P0.2) and Primary (P1.0), while FEC FEC P0.1×P0.2×P0.3×P0.4 indicates that error correction data is provided for Primary (P0.1), Primary (P0.2), Primary (P0.3), and Primary (P1.0). The error correction encoder 200 may specify this error correction data in the audio encoding bitstream 31 in a subsequent packet that includes Primary (P1.1).

In one example, correlated data (e.g., Primary) is encoded using a 132 byte frame using the MDCT audio encoder 24. Lossless residual data (shown as “Secondary”) is then added at the end and will make up 800 bytes. Error correction encoder 200 may then add two FEC blocks of a total size of 264 bytes, which may not be considered large compared to the full packet. The audio encoder 24B may provide FEC to minimize streaming (such as gaming) latency when there may only be time to send two retries over a wireless link. These two extra FEC blocks may allow for 9 error recovery attempts instead of 3. As noted above, there may be limits to the number of attempts when transmitting the encoded audio bitstream 31 over a WiFi™ access point (AP) and using FEC may improve the reliability of the wireless link.

With respect to wireless network (such as WiFi™) retries, the wireless network may attempt to transmit data several times, where in some instances the wireless network may start with a higher modulation mode before transitioning to a relatively lower modulation mode. One potential issue when merging audio links is a potential drop in bitrate transitioning between modulation modes. In terms of WiFi™, these modulation modes are denoted as MSC0, MSC1, MSC2, MSC3, etc., where the larger the number, the higher the modulation. Consider that, for a 96 kilo-Hertz (kHz) lossless audio stream, packet transmission delays can rise from 7.6 ms at MSC3 to 30.49 ms at MSC0.

These transmission delays may lead to congesting and instability across the entire wireless network. In some implementations, feedback regarding the state of the transmission link (or, in other words, the wireless link) is provided to the audio encoder to prompt a reduction in the bitrate, which may result in considerable data loss and a more restrained approach. As such, the instability of wireless links may render lossless audio streaming less effective.

That is, the efficiency of lossless audio encoding may be constrained by two factors. The first factor is the requirement of alternating between lossless and lossy codecs. The second factor is driving by the potential need to promptly reduce quality when the wireless link begins to falter. By employing MDCT audio encoder 224, the audio encoder 24B may avoid switching between lossless and lossy audio encoding. Additionally, the residual encoder 234 may organize the residual data (shown as “Secondary” in the example of FIG. 3A) into packets, starting with the most significant bit of the residual data in a process known as “bit slicing.” The following tables illustrates an example of bit slicing within packets.

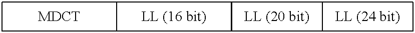

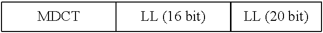

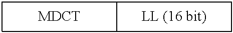

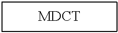

In this way, the audio encoder 24B may allow for packet truncation (assuming each table above represents a different version of the same packet) according to the selected MSC0-MSC3, and possibly ensuring that as modulation diminishes during transmission, packets can be truncated to effectively handle congestion. In this way, the audio encoder 24B may dynamically adjust the encoded audio data 25 based on a state of the transmission link over which the encoded audio bitstream 31 is transmitted.

Although dynamically adjusting the encoded audio data 25 in this manner may allow for seamless transitions of bitrate to accommodate different modulation states, the audio decoder 44 may perform various operations to correct for errors, such as by implementing a real time soft combiner (RTSC). RTSC may utilize retry packets on either side of a packet to facilitate error correction, effectively performing a bit-by-bit majority vote across the original packet and retry packets. RTSC may therefore be adjusted to account for variable length packets due to the bit slicing process above in which packets may be truncated due to a drop in modulation.

In this way, a floating-point codec (e.g., the MDCT audio encoder 224) may be used, which may greatly speed up development since implementing fixed-point methods can delay the process by months (if not a year or more) compared to floating-point techniques. Moreover, audio encoder 24B may support the use of a high compression algorithm and FEC to protect MDCT frames, while also providing the option to remove residuals if needed. Further, the audio encoder 24B may employ optimized MDCT libraries, which may significantly reduce the amount of table data and code within the codec. Embedded systems often face demands to function within tight resource limits, and reuse of the underlying MDCT codec may meet these demands.

FIG. 3B is a block diagram illustrating another example of the audio encoder that includes error correction in accordance with various aspects of the techniques described in this disclosure. While the example of FIG. 3A illustrated a FEC that provides error correction for twelve samples (or, in other words, segments, packets, portions, etc.) of the audio data 21, the audio encoder 24C (which may represent another example of the audio encoder 24) may implement a simpler FEC encoding (compared to audio encoder 24A) that produces a FEC block (per sample, packet, portion, segment, etc.) that the audio encoder 24B may add to the audio encoded bitstream 21, where the FEC block is the XOR of the two previous MDCT generated blocks.

As can be understood from the example of FIG. 3B, the FEC blocks may contain error correction data for Primary (MDCT block) P1.1-P0.0×P1.0, Primary (MDCT block) 1.2-P1.0×P1.1, Primary (MDCT block) P1.3-P1.1×P1.2, Primary (MDCT block) 2.0-P1.2×P1.3, Primary (MDCT block) P2.1-P1.3×P2.0, Primary (MDCT block) 2.2-P2.0×P2.1, Primary (MDCT block P2.3)-P2.1×P2.2. As such, the audio encoder 24B may specify error correction data in a subsequent packet, where ‘X’ denotes the XOR between the two primary (P) blocks denoted by, as an example, P0.0 and P1.0 in the example of Primary block P1.1. The audio encoder 24B may continue in this manner specifying error correction data (e.g., FEC blocks) for each sample, segment, block, packet, etc.) in the subsequent (and likely the directly subsequent next portion of the encoded audio bitstream 31 to facilitate latency requirements and allow for the most attempts at error correction).

If configured (e.g., due to bandwidth limitations, quality of service limitations, latency requirements), the audio encoder 24B may insert the FEC blocks every other packet, and the audio decoder 44 may be able to determine that the FEC block is missing. This reduction in FEC blocks may include the latency needed for the FEC so for this example, it is assumed that the FEC block is added every new MDCT block for purposes of illustration.

FIG. 3C is a block diagram illustrating an example of the audio encoded bitstream that includes the error correction data in accordance with various aspects of the techniques described in this disclosure. As shown in the example of FIG. 3C, an audio encoded bitstream 31A may represent an example of the audio encoded bitstream 31 shown in the example of FIG. 1. The audio encoded bitstream 31A may include a 1-byte (although other byte arrangements may be considered) FEC frame header 300 where the audio encoder 24C sets the most significant bit (MSB) to logic ‘1.’ The audio encoder 24C may set the lowest significant bit (LSB) at the start of a four-packet cycle to a logic ‘0,’ or in other words, low. For FEC blocks generated in the second, third, and fourth slots, the audio encoder 24C may set the LSB to a logic ‘1.’

The audio encoder 24C may obtain a FEC block using an XOR of the TID0 headers and the MDCT blocks from the two previous packets (obtaining XOR block 302, which is inserted into the audio encoded bitstream 31A). In this instance, the lossless block may not be protected (meaning, using error protection). The audio encoder 24C may apply the XOR to the entire MDCT generated block, but in other examples, portions of the MDCT generated block may be protected (such as the coarse grain energy values, or both the coarse grain energy values and the fine grain energy values, as well as other aspects of the encoded audio data). As shown in the example of FIG. 3B, the FEC block in P2.1 may include the XOR of the P1.3 and P2.0 MDCT Primary blocks.

In some examples, the audio encoder 24C may provide the FEC blocks for an encoded segment of the audio encoded bitstream 31 sent via BLUETOOTH or otherwise wireless connection links, which may perform an EXOR the primary blocks from the previous two blocks. Other wireless connection links may include a WiFi™ wireless link, other personal area network links, etc.

FIG. 3D is a diagram illustrating example operation of the audio decoding device shown in the example in FIG. 1 in performing various aspects of the error correction techniques described in this disclosure. In the example of FIG. 3D, the audio decoder 44 may receive the audio encoded bitstream 31 as a stream of one or more packets via a wireless link (e.g., a WiFi™ wireless link, a personal area network—PAN—wireless link, etc.). Streaming of packets may be subject to a latency requirement defined via the QoS requirements managed and/or negotiated by the wireless connection manager 26/wireless connection manager 40 shown in the example of FIG. 1.

In FIG. 3D, the audio decoder 44 may receive a packet (“Pkt”) 1.3 (which is the packet before lost packet 2.0) and a packet 2.1 (which is the packet after missing packet 2.0), and thereby determine (e.g., via a sequence number associated with each packet in the stream of packets) that packet 2.0 is missing (as the packets come in streams of four, e.g., packet 1.3, packet 2.0, packet 2.1, packet 2.2). That is, the packets are grouped in fours, which provides for, as an example, packet 1.0, packet 1.1, packet 1.2, and packet 1.3.

The audio decoder 44 may extract the TID0 header 302 and the MDCT block for packet 1.3. The audio decoder 44 may also extract the FEC block (which is another way to refer to error correction data) from packet 2.1. Next, the audio decoder 44 may perform error correction with respect to the TID0 header 302 and the MDCT block for packet 1.3 using error correction data from packet 2.1 (e.g., performing a bit-wise XOR operation with respect to the TID0 header and the MDCT block extracted from packet 1.3 and the extracted FEC block from subsequent packet 2.1). The audio decoder 44 may, as a result of performing the error correction, recover packet 2.0 (which was missing, lost, or otherwise corrupted), which the audio decoder 44 may pass to the MDCT audio decoder (as described in more detail herein).

In other words, various aspects of the error correction techniques may provide a basic design to restore a stream when there is a lost packet (or, in other words, an example of a corrupted portion of the audio encoded bitstream 31). In the scheme described above with respect to the example of FIG. 3B, the audio encoder 24C may generate the FEC block for every new packet. This scheme has the potential for improved recover with the use of more advanced coding.

In this instance, the FEC block in the packet after a lost packet contains the XOR of the TID0 header and MDCT block (or, in other words, data) 302. The audio decoder 44 may XOR this XOR of the TID0 header and the MDCT block 302 with the packet before the lost packet to enable recovery of the TID-header and the MDCT data of the lost packet. The audio decoder 44 may then decode this complete packet, but may not attempt to decode the residual data due to the loss of the packet (as it is not protected by error correction in this instance).

FIG. 3E is a diagram illustrating example operation of an audio encoder in performing various aspects of the advanced error correction techniques involving a jitter queue. In the example of FIG. 3E, the audio encoder 24D may represent another example of the audio encoder 24 shown in the example of FIG. 1. The audio encoder 24D may include the components. In addition, the audio encoder 24D may represent a variation of the audio encoder 24C, where the audio encoder 24D may implement an algorithm that includes a jitter queue. The audio encoder 24D may implement or otherwise perform various aspects of the error correction techniques described herein in a similar manner to that described above with respect to the audio encoder 24A shown in the example of FIG. 3A, although FIG. 3E illustrates an example of a 12 packet forward error correction scheme (whereas FIG. 3A illustrates an example of an N packet forward error correction scheme and is therefore more generalized).

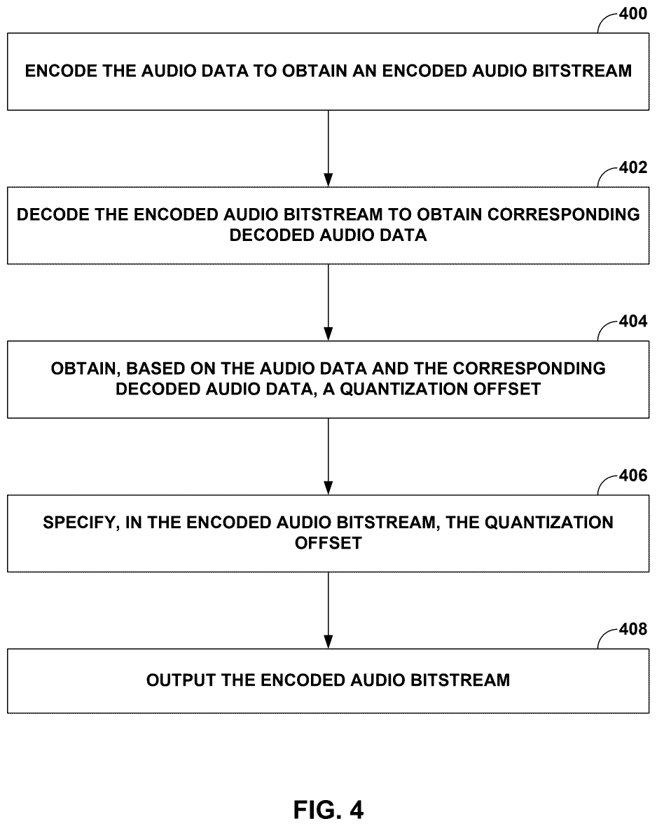

FIG. 4F is a diagram illustrating example operation of the audio decoder shown in the example of FIG. 1 in performing various aspects of the advanced error correction techniques involving a jitter queue. In the example of FIG. 4F, the audio decoder 44 may receive a packet (350) and initiate a number of possibly concurrent processes. The audio decoder 44 may store (or otherwise place) the packet in the jitter queue (where it is assumed that there is a sequence number assigned to each packet, such as found in the real time packet header, and an index into the queue is generated from this sequence number) (352). Jitter, in the context of audio coding, refers to small, rapid variations in the timing of a signal's transmission or playback, which may affect digital audio systems and can occur due to packet arrival times varying due to network congestion (that may lead to dropouts or latency variations). In this instance, the audio decoder 44 may replace a FEC generated packet (which may be generated for each packet or some other periodicity of packets) with a received packet.

The audio decoder 44 may update a 64-bit “holes” mask, which tracks the received packet (354). Using a bitmask may make it simple to find the FEC that will fix the holes (which is another way to refer to missing, lost, or otherwise corrupted packets). The audio decoder 44 may attach to the entries missing a packet and determine whether any of the FEC blocks can be used to fix the hole, and apply the FEC block to fix the hole and thereby generate the missing MDCT block (356). In this instance, the 64-bit hole mask are used to possibly make the process faster and more efficient.

That is, the audio decoder 44 may initiate multiple processes that occur concurrently. While updating the jitter queue and updating the hole mask, the audio decoder 44 may concurrently also parse out the FEC blocks (358), where as noted above, each packet may contain zero or more FEC blocks (e.g., 1 or 2 FEC blocks as shown and described herein). The audio decoder 44 may populate a 64 bit EXOR mask giving the packet to which the FEC applies (or, in other words, covers) (360). In this example, there may be a mask for each FEC block and this marks what MDCT blocks were EXORed to generate the FEC block. If there is all but one of the MDCT blocks, we can fix the so-called ‘hole.’ The audio decoder 44 may determine (or otherwise “check”) each FEC block to see if the FEC block covers any holes (where if no FEC block covers the hole, the audio decoder 44 may drop or otherwise delete, remove, etc. the FEC block, but in instances where a FEC block covers the hole, the audio decoder 44 may add the FEC block to the entries missing a packet) (362). The audio decoder 44 may utilize these entries as a possible candidate to cover the missing packet (354). Once added or removed, the audio decoder may free the FEC block (364).

The audio decoder 44 may next determine if the error corrected audio data (e.g., the generated MDCT block) can be combined with any other FEC blocks to fix another missing packet (366). The audio decoder 44 may repeat this processes until no more holes can be found to be repaired. The audio decoder 44 may next determine if the logical AND of the FEC mask and inverse of the holes mask is zero. When the result of the logical AND of the FEC mask and inverse of the holes mask is zero, the audio decoder 44 may determine that the FEC block is no longer in use and delete or otherwise “clear up” the FEC blocks that are no longer in use (368).

The following presents a summary with explanation of example code executed—which may also represent a hardware only description of the operations performed—by the audio decoder 44 in accordance with the various aspects of the advanced error correction techniques involving a jitter queue.

dumpFix

Purpose: Print details of a fixed segment, including its mask and sequence number.

### Algorithm:

1. Print the fix mask and sequence number.
2. Iterate through the data buffer and print each byte in hexadecimal format.
3. Format the output for readability.

### AxFixEXOR

Purpose: Perform an XOR operation on two fixed segments and store the result in pOut.

### Algorithm:

1. Iterate through the data buffers of pFixA and pFixB.
2. Perform XOR on corresponding elements and store the result in pOut.
3. Print the details of the input and output segments using _dumpFix.

### AxFixAssign

Purpose: Assign values from pFixA to pOut and set the fix mask and sequence number.

### Algorithm:

1. Copy the write pointer and data buffer from pFixA to pOut.
2. Set the fix mask and sequence number in pOut.
3. Ensure the buffer size does not exceed the maximum allowed size.

### AxFixListAdd

Purpose: Add a fixed segment to a list of new fixes.

### Algorithm:

1. Ensure the list is not full.
2. Add the fixed segment to the list and increment the count.

### AxEtyAddFix

Purpose: Add a fixed segment to the jitter queue and update the hole mask.

### Algorithm:

1. Calculate the index based on the sequence number.
2. Reset the entry in the jitter queue.
3. Allocate a new segment and set its properties.
4. Update the hole mask and reference count.

### AxQjChkFix

Purpose: Check if a new fix can resolve any holes in the jitter queue and add it if possible.

### Algorithm:

1. Calculate the difference between write and read sequence numbers.
2. Iterate through the jitter queue entries.
3. Check for overlapping fix masks.
4. If a fix can resolve a hole, perform XOR and add the fix to the queue.

### AxQjAddFix Function

This function adds a fix to the jitter queue and updates the hole mask, handling various scenarios.

### Algorithm:

### 1. Function Entry

Log the function entry for debugging purposes.
Calculate Difference
Calculate the difference between the write sequence number (uSNWrite) and the read sequence number (uSNRead): int32_t nDif=(pJQ->uSNWrite-pJQ->uSNRead) & AXJQ_PKT_MASK;

### Initialize Variables

```
Initialize the fix pool and read sequence number:
axJQFixPool_t* pFixPool = pJQ−>pFixPool;
uint16_t uSNRead = pJQ−>uSNRead;
Allocate New Segment
Allocate a new segment from the fix pool and assign values from the input fix:
axSESeg_t* pOut = AxJqFixPoolNew(pFixPool);
AxFixAssign(pOut, pFix, uFixMaskOfs, pJQ−>uSNWrite);
Iterate Through Jitter Queue Entries
Iterate through the jitter queue entries to check for overlapping fix masks:
for (int32_t nIdx = 0; nIdx < nDif; nIdx++, uSNRead++) {
  uint16_t nIdx_= uSNRead & AXJQ_PKT_MASK;
  axJitterQQ_t* pEty = pJQ−>q + nIdx_;
  axSEContainer_t* pSeg = pJQ−>q[nIdx_].pSeg;
  int32_t nFillMaskOfs = pJQ−>uSNWrite − uSNRead;
  if (pEty−>pSeg == NULL) {
    continue;
  }
  if (uSNRead != pSeg−>fixSeg.blk[0].d.fix.uSeqNum)
    AXASSERT(uSNRead == pSeg−>fixSeg.blk[0].d.fix.uSeqNum);
  AXCOMMENT_FEC(“%3d - MASK: %06x SN: %3d\n”, nIdx_, 1 << nFillMaskOfs,
pSeg−>fixSeg.blk[0].d.fix.uSeqNum);
Check Fix Types
Check the type of each fix and handle accordingly:
for (int32_t nIF = 0; nIF < pSeg−>fixSeg.uCnt; nIF++) {
  axSESeg_t* pFill = pSeg−>fixSeg.blk + nIF;
  switch (pFill−>d.fix.uType) {
    default:
```

continue;

```
    case AXLW_CYC_NEW:
    case AXLW_CYC_3:
    case AXLW_CYC_4:
    case AXLW_CYC_5:
```

break;

```
  }
  uint32_t uFillMaskShf = pFill−>d.fix.uFixMask << nFillMaskOfs;
```

| | |
|---|---|
| 2. | Perform XOR Operation |

Perform XOR operation if the fill mask overlaps with the output fix mask:
if ((uFillMaskShf & pOut−>d.fix.uFixMask) == 0) {
continue;
}
pOut−>d.fix.uFixMask & = ~uFillMaskShf;
AxFixEXOR(pOut, pOut, pFill, pJQ−>uSNWrite);

| | |
|---|---|
| 3. | Update Hole Mask |

```
Update the hole mask and add the fix to the jitter queue if indicated:
if (pJQ−>fec.uHolesMash & pOut−>d.fix.uFixMask & (1ll << nFillMaskOfs)) {
  AXCOMMENT_FEC(“Add fix SN: %3d\n”, uSNRead);
  if (pOut−>d.fix.uFixMask == (1ll << nFillMaskOfs)) {
    pOut−>buf.nRPtr = 0;
    AxEtyAddFix(pJQ, pOut, uSNRead);
    AxFixListAdd(pFixNewList, pOut);
  } else {
    pEty−>aFix[pEty−>nFixCnt] = pOut;
    pEty−>nFixCnt++;
    pOut−>d.fix.nRef++;
  }
}
```

| | |
|---|---|
| 4. | Free Unused Fix |

```
Free the fix if it is not referenced:
if (0 == pOut−>d.fix.nRef) {
  AxJqFixPoolFree(pFixPool, pOut);
  return;
}
```

### SUMMARY

The AxQjAddFix function handles the addition of fixes to the jitter queue and updates the hole mask. It performs the following steps:
1. Calculate the difference between write and read sequence numbers.
2. Allocate a new segment and assign values from the input fix.
3. Iterate through the jitter queue entries to check for overlapping fix masks.
4. Check the type of each fix and handle accordingly.
5. Perform XOR operation if the fill mask overlaps with the output fix mask.
6. Update the hole mask and add the fix to the jitter queue if necessary.
7. Free the fix if it is not referenced.

### AxJitterQAddWithFEC

Purpose: Add a segment to the jitter queue with FEC handling.

### Algorithm:

Function Entry
Log the function entry for debugging purposes.
Add Segment to Jitter Queue
Add the segment to the jitter queue using AxJitterQAdd.
Calculate Mask Offset
Calculate the mask offset based on the write sequence number and the segment's sequence number:
int32 t nMaskOfs=pJQ->uSNWrite-pSeg->pRtp->rtp.uSeqNum; AXASSERT(nMaskOfs>=0); AXASSERT(nMaskOfs<AXJQ_PKT_MAX);
1. Enable FEC
Enable FEC and initialize if necessary:

```
pJQ−>fec.nEnabled = 1;
if (pJQ−>fec.nInit) {
  pJQ−>fec.nSeqNumBase = (uint16_t)(pSeg−>pRtp−>rtp.uSeqNum − pFix −
>d.fix.uType);
  pJQ−>fec.nInit = 0;
}
Iterate Through Fixes
Iterate through the fixes in the segment and set the fix mask and type based on the FEC
slot:
for (int32_t nIdx = 0; nIdx < pSeg−>fixSeg.uCnt; nIdx++) {
  axSESeg_t* pFix = &pSeg−>fixSeg.blk[nIdx];
  pFix−>d.fix.uType = ((*pFix−>buf.dat.pu8) >> 4) & 0x7;
  axR4LLWarpFecSlot_t uSlot = (pSeg−>pRtp−>rtp.uSeqNum − pJQ −
>fec.nSeqNumBase) % 5;
  pFix−>d.fix.uFixMask = 0;
  pFix−>d.fix.uSeqNum = pSeg−>pRtp−>rtp.uSeqNum;
  switch (pFix−>d.fix.uType) {
    case AXLW_CYC_NEW:
      pFix−>d.fix.uFixMask = 1;
      pJQ−>fec.uHolesMash &= ~((AXFECIGOREHOLES) << 4);
      break;
    case AXLW_CYC_3:
    case AXLW_CYC_4:
    case AXLW_CYC_5:
      pJQ−>fec.uHolesMash &= ~((AXFECIGOREHOLES) << (pFix−>d.fix.uType −
1));
      pFix−>d.fix.uFixMask = 1;
      break;
    case AXLW_CYC_2:
      pFix−>d.fix.uFixMask = 1 << (21 − 14) | 1 << (21 − 15) | 1 << (21 − 17);
      pJQ−>fec.uHolesMash &= ~(AXFECIGOREHOLES);
      break;
    case AXLW_FEC_AC:
      switch (uSlot) {
        case AXLW_CYC_NEW:
          pFix−>d.fix.uFixMask = 1 << (10 − 2) | 1 << (10 − 4);
          break;
        case AXLW_CYC_2:
          pFix−>d.fix.uFixMask = 1 << (10 − 4) | 1 << (10 − 5);
          break;
        case AXLW_CYC_3:
          pFix−>d.fix.uFixMask = 1 << (22 − 13) | 1 << (22 − 15);
          break;
        case AXLW_CYC_4:
          pFix−>d.fix.uFixMask = 1 << (13 − 7) | 1 << (13 − 4);
          break;
        case AXLW_CYC_5:
          pFix−>d.fix.uFixMask = 1 << (9 − 0) | 1 << (9 − 3);
          break;
        default:
          pFix−>d.fix.uFixMask = 0;
          break;
      }
      break;
    case AXLW_FEC_DE:
      switch (uSlot) {
        case AXLW_CYC_NEW:
          pFix−>d.fix.uFixMask = 1 << (10 − 5) | 1 << (10 − 7);
          break;
        case AXLW_CYC_2:
          pFix−>d.fix.uFixMask = 0;
          break;
        case AXLW_CYC_4:
          pFix−>d.fix.uFixMask = 1 << (8 − 3) | 1 << (8 − 4);
          break;
        case AXLW_CYC_5:
          pFix−>d.fix.uFixMask = 0;
          break;
        default:
          pFix−>d.fix.uFixMask = 0;
          break;
      }
      break;
    case AXLW_FEC_W:
      switch (uSlot) {
        case AXLW_CYC_2:
          pFix−>d.fix.uFixMask = 1 << (16 − 7) | 1 << (16 − 8) | 1 << (16 − 10) | 1 <<
(16 − 13);
          break;
        case AXLW_CYC_3:
          pFix−>d.fix.uFixMask = 1 << (17 − 7) | 1 << (17 − 8) | 1 << (17 − 9) | 1 <<
(17 − 10);
          break;
        case AXLW_CYC_5:
          pFix−>d.fix.uFixMask = 1 << (19 − 8) | 1 << (19 − 9) | 1 << (19 − 12) | 1 <<
(19 − 14);
          break;
        default:
          pFix−>d.fix.uFixMask = 0;
          break;
      }
      break;
  }
}
Check for Overlapping Fix Masks and Add Fixes to the Queue
Check for overlapping fix masks and add fixes to the queue:
for (int32_t nIdx = 0; nIdx < pSeg−>fixSeg.uCnt; nIdx++) {
  axSESeg_t* pFix = &pSeg−>fixSeg.blk[nIdx];
  if (pJQ−>fec.nInit) {
    continue;
  }
  uint32_t uFixMaskOfs = pFix−>d.fix.uFixMask;
  uFixMaskOfs <<= nMaskOfs;
  if ((uFixMaskOfs & (pJQ−>fec.uHolesMash)) == 0) {
    continue;
  }
  axSEFixList_t aFixNewList;
  AXCLRSTRUCT(aFixNewList);
  AxQjAddFix(pJQ, pFix, uFixMaskOfs, &aFixNewList);
  while (aFixNewList.uCnt > 0) {
    aFixNewList.uCnt--;
    axSESeg_t* pFixNu = aFixNewList.ary[aFixNewList.uCnt];
    AxQjChkFix(pJQ, pFixNu, &aFixNewList);
  }
}
Iterate Through Jitter Queue Entries and Update the Hole Mask
Iterate through the jitter queue entries and update the hole mask:
int32_t nDf = (pJQ−>uSNWrite − pJQ−>uSNRead) & AXJQ_PKT_MASK;
uint32_t uSNWrite = pJQ−>uSNWrite;
for (int32_t nIdx = 0; nIdx < nDf; nIdx++, uSNWrite--) {
  axSEContainer_t* pSeg_ = pJQ−>q[uSNWrite & AXJQ_PKT_MASK].pSeg;
  if (NULL == pSeg_) {
    continue;
  }
  // Additional processing for each segment if necessary
}
```

### Example Explanations for Each Function

dumpFix
Use Case: Debugging and logging the details of fixed segments.
Explanation: This function prints the fix mask, sequence number, and data buffer of a fixed segment for debugging purposes.

### AxFixEXOR

Use Case: Combining two fixed segments using XOR operation.
Explanation: This function performs an XOR operation on the data buffers of two fixed segments and stores the result in the output segment. It is used to combine fixes and resolve packet loss.

### AxFixAssign

Use Case: Assigning values from one fixed segment to another.
Explanation: This function copies the data buffer, fix mask, and sequence number from one fixed segment to another. It is used to initialize new fixes.

### AxFixListAdd

Use Case: Managing a list of new fixes.
Explanation: This function adds a fixed segment to a list of new fixes. It is used to keep track of fixes that need to be processed.

FIG. 4 is a flowchart illustrating example operation of the source device 12 of FIG. 1 in performing various aspects of the techniques described in this disclosure. The source device 12 may invoke the audio encoder 24 to encode the audio data and thereby obtain an encoded audio bitstream 21 (400). The audio encoder 24 may also decode the encoded audio bitstream to obtain corresponding decoded audio data (402). The audio encoder 24 may obtain, based on the audio data 21/23 and the corresponding decoded audio data 21′/23′, a QO 55 (404). The audio encoder 24 may specify, in the encoded audio bitstream 31, the QO 55 (406), and then output the encoded audio bitstream 31 (408).

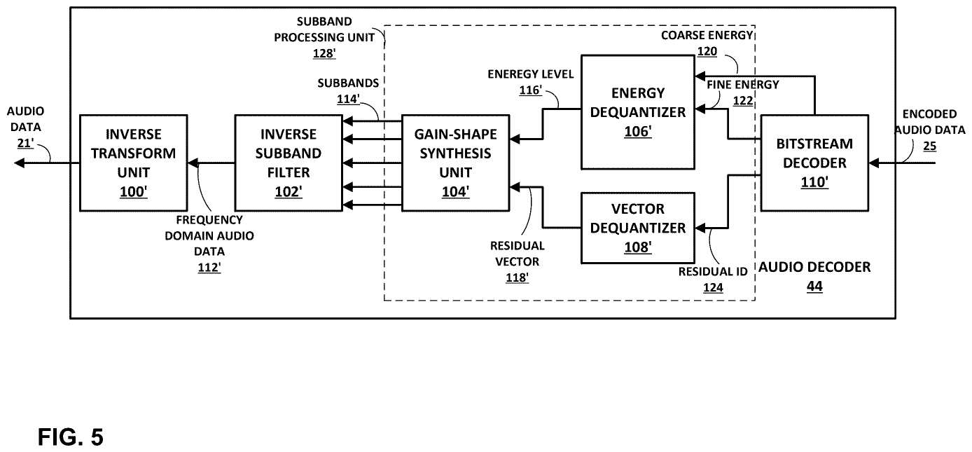

FIG. 5 is a block diagram illustrating an implementation of the audio decoder 44 of FIG. 1 in more detail. The audio decoder 44 may be configured to decode audio data received over a PAN (e.g., Bluetooth®). However, the techniques of this disclosure performed by the audio decoder 44 may be used in any context where the compression of audio data is desired, including wireless networks (such as a WiFi™ wireless network). In some examples, the audio decoder 44 may be configured to decode the audio data 21′ in accordance with as aptX™ audio codec, including, e.g., enhanced aptX—E-aptX, aptX live, and aptX high definition. However, the techniques of this disclosure may be used in any audio codec configured to perform audio encoding to achieve lossless audio coding while still allowing for FEC, bit slicing, etc.

In general, audio decoder 44 may operate in a reciprocal manner with respect to audio encoder 24. As such, the same process used in the encoder for lossless audio encoding relying on a post-decoder residual coding can be used in the audio decoder 44. The decoding is based on the same principals, with inverse of the operations conducted in the decoder, so that audio data can be reconstructed from the encoded bitstream received from the audio encoder 24 (including one or both of the audio encoder 24A and/or the audio encoder 24B).

The audio decoder 44 may include a bitstream decoder 110′ and a subband processing unit 128′. The bitstream decoder 110′ is configured to parse the encoded audio data 25 to extract various quantized parameters, including coarse energy 120, fine energy 122, and a residual ID 124. The subband processing unit 128′ receives these extracted parameters and operates to generate reconstructed subbands 114′. The subbands 114′ are subsequently passed to an inverse subband filter 102′, which synthesizes the subbands 114′ to reconstruct frequency domain audio data 112′. An inverse transform unit 100′ is then configured to apply an inverse frequency transform, such as an inverse modified discrete cosine transform (IMDCT), to the frequency domain audio data 112′ to obtain the decoded audio data 21′ in the time domain.

Within the subband processing unit 128′, an energy dequantizer 106′ may be configured to process the coarse energy 120 and the fine energy 122 to obtain an energy level 116′. Concurrently, a vector dequantizer 108′ may process the residual ID 124 to determine a residual vector 118′. A gain-shape synthesis unit 104′ is configured to combine and synthesize the energy level 116′ and the residual vector 118′ to output the subbands 114′. In this manner, the components of the audio decoder 44 operate in a reciprocal fashion to the corresponding components of the audio encoder to effectively reconstruct the audio signal from the encoded bitstream.

The audio decoder 44 represents a device configured to invoke the bitstream decoder 110′ to parse the encoded audio data 25, the entropy encoded residual data 167, the entropy codes 169 indicative of the quantization offset, and the FEC or other error correction data from the encoded audio bitstream 31. The bitstream decoder 110′ may pass the encoded audio data 25 to an MDCT audio decoder (which operates inversely to the MDCT audio encoder 234 shown in the example of FIG. 3A to obtain decoded audio data 21′). The MDCT audio decoder may pass the decoded audio data 21′ to an error correction unit, which performs error correction (such as forward error correction—FEC) with respect to the decoded audio data 21′ in order to output, to an arithmetic unit, error corrected audio data. As such, the error correction unit may obtain, from a first sample of the encoded audio bitstream 31, error correction data from a subsequent second sample of the encoded audio bitstream 31, and perform, based on the error correction data, error correction with respect to the first sample to obtain an error corrected sample (forming part of error corrected audio data).

The MDCT audio decoder may also pass the decoded audio data 21′ to the residual decoder, while the bitstream decoder 110′ may further pass the entropy encoded residual data and the entropy codes to a residual decoder. The residual decoder may apply the entropy codes to the decoded audio data 21′ to obtain corrected residual audio data. As one example, the entropy codes 169 may represent a combination of one or more QOs (e.g., a single QO or two or more QOs) and perform entropy decoding with respect to the entropy codes 169 to reconstruct the indication of the QO for one or more (including all) samples of decoded audio data 21′.

Using this indication of the QO, the residual decoder may first apply the implicitly signaled baseline offset to a sample of the decoded audio data 21′ to which the QO corresponds to obtain an adjusted sample. The residual decoder may next apply the indication of the QO to the adjusted sample to obtain an offset sample, and then apply the implicitly signaled bitmask to one or more bits of the offset sample of the decoded audio data to obtain a masked sample. The residual decoder may reapply the baseline offset to the masked sample to obtain a readjusted sample and obtain, based on the residual data specified in the encoded audio bitstream 31 and the readjusted sample, a bit accurate sample of the decoded audio data 21′. The residual decoder may output the readjusted samples as corrected residual audio data.

The arithmetic unit may represent a unit configured to perform mathematical operations (such as a sum) with respect to the error corrected audio data and the corrected residual audio data. The arithmetic unit may add the corrected residual audio data to the error corrected audio data and thereby obtain audio data 21′ having a bit difference within the tolerable level.

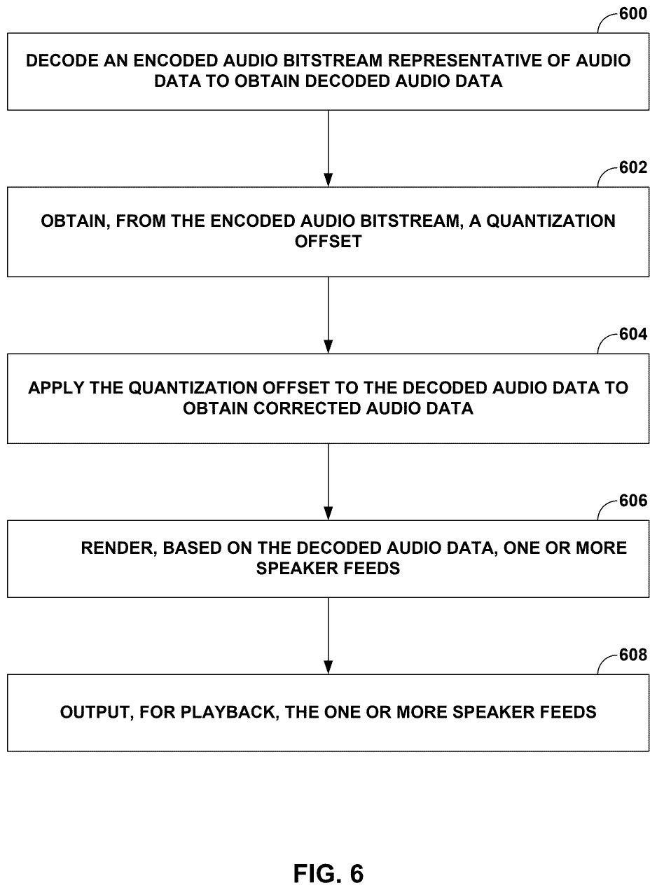

FIG. 6 is a flowchart illustrating example operation of the sink device 14 of FIG. 1 in performing various aspects of the techniques described in this disclosure. The sink device 14 may invoke the audio decoder 44, which may decode the encoded audio bitstream 31 representative of the audio data 21/23 to obtain decoded audio data 23′ (600). The audio decoder 44 may next obtain, from the encoded audio bitstream 31, the QO 55 (602). The audio decoder 44 may apply the QO 55 to the decoded audio data 23′ to obtain corrected audio data (where the QO 55 may correct for any bit differences between original audio data that was encoded to obtain the encoded audio bitstream 31 and the decoded audio data 21′/23′ (604). The audio decoder 44 may render, based on the decoded audio data 21′/23′ to one or more speaker feeds (606), and then output, for playback, the one or more speaker feeds (608).

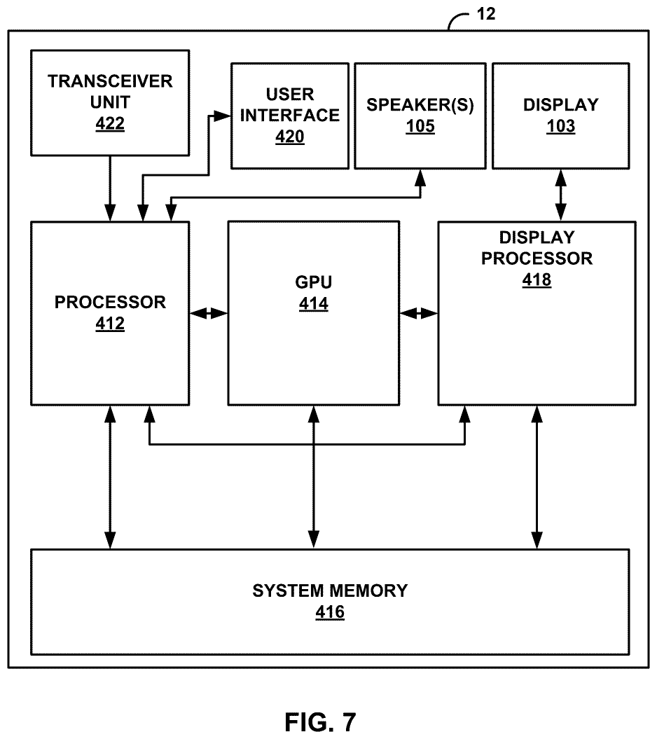

FIG. 7 is a block diagram illustrating example components of the source device 12 shown in the example of FIG. 1. In the example of FIG. 7, the source device 12 includes a processor 412, a graphics processing unit (GPU) 414, system memory 416, a display processor 418, one or more integrated speakers 105, a display 103, a user interface 420, and a transceiver unit 422. In examples where the source device 12 is a mobile device, the display processor 418 is a mobile display processor (MDP). In some examples, such as examples where the source device 12 is a mobile device, the processor 412, the GPU 414, and the display processor 418 may be formed as an integrated circuit (IC).

For example, the IC may be considered as a processing chip within a chip package and may be a system-on-chip (SoC). In some examples, two of the processors 412, the GPU 414, and the display processor 418 may be housed together in the same IC and the other in a different integrated circuit (i.e., different chip packages) or all three may be housed in different ICs or on the same IC. However, it may be possible that the processor 412, the GPU 414, and the display processor 418 are all housed in different integrated circuits in examples where the source device 12 is a mobile device.

Examples of the processor 412, the GPU 414, and the display processor 418 include, but are not limited to, one or more digital signal processors (DSPs), general purpose microprocessors, application specific integrated circuits (ASICs), field programmable logic arrays (FPGAs), or other equivalent integrated or discrete logic circuitry. The processor 412 may be the central processing unit (CPU) of the source device 12. In some examples, the GPU 414 may be specialized hardware that includes integrated and/or discrete logic circuitry that provides the GPU 414 with massive parallel processing capabilities suitable for graphics processing. In some instances, GPU 414 may also include general purpose processing capabilities, and may be referred to as a general-purpose GPU (GPGPU) when implementing general purpose processing tasks (i.e., non-graphics related tasks). The display processor 418 may also be specialized integrated circuit hardware that is designed to retrieve image content from the system memory 416, compose the image content into an image frame, and output the image frame to the display 103.

The processor 412 may execute various types of the applications 20. Examples of the applications 20 include web browsers, e-mail applications, spreadsheets, video games, other applications that generate viewable objects for display, or any of the application types listed in more detail above. The system memory 416 may store instructions for execution of the applications 20. The execution of one of the applications 20 on the processor 412 causes the processor 412 to produce graphics data for image content that is to be displayed and the audio data 21 that is to be played (possibly via integrated speaker 105). The processor 412 may transmit graphics data of the image content to the GPU 414 for further processing based on instructions or commands that the processor 412 transmits to the GPU 414.

The processor 412 may communicate with the GPU 414 in accordance with a particular application processing interface (API). Examples of such APIs include the DirectX® API by Microsoft®, the OpenGL® or OpenGL ES® by the Khronos group, and the OpenCL™; however, aspects of this disclosure are not limited to the DirectX, the OpenGL, or the OpenCL APIs, and may be extended to other types of APIs. Moreover, the techniques described in this disclosure are not required to function in accordance with an API, and the processor 412 and the GPU 414 may utilize any technique for communication.

The system memory 416 may be the memory for the source device 12. The system memory 416 may comprise one or more computer-readable storage media. Examples of the system memory 416 include, but are not limited to, a random-access memory (RAM), an electrically erasable programmable read-only memory (EEPROM), flash memory, or other medium that can be used to carry or store desired program code in the form of instructions and/or data structures and that can be accessed by a computer or a processor.

In some examples, the system memory 416 may include instructions that cause the processor 412, the GPU 414, and/or the display processor 418 to perform the functions ascribed in this disclosure to the processor 412, the GPU 414, and/or the display processor 418. Accordingly, the system memory 416 may be a computer-readable storage medium having instructions stored thereon that, when executed, cause one or more processors (e.g., the processor 412, the GPU 414, and/or the display processor 418) to perform various functions.

The system memory 416 may include a non-transitory storage medium. The term “non-transitory” indicates that the storage medium is not embodied in a carrier wave or a propagated signal. However, the term “non-transitory” should not be interpreted to mean that the system memory 416 is non-movable or that its contents are static. As one example, the system memory 416 may be removed from the source device 12 and moved to another device. As another example, memory, substantially similar to the system memory 416, may be inserted into the source device 12. In certain examples, a non-transitory storage medium may store data that can, over time, change (e.g., in RAM).

The user interface 420 may represent one or more hardware or virtual (meaning a combination of hardware and software) user interfaces by which a user may interface with the source device 12. The user interface 420 may include physical buttons, switches, toggles, lights or virtual versions thereof. The user interface 420 may also include physical or virtual keyboards, touch interfaces—such as a touchscreen, haptic feedback, and the like.

The processor 412 may include one or more hardware units (including so-called “processing cores”) configured to perform all or some portion of the operations discussed above with respect to one or more of the mixing unit 22, the audio encoder 24, the wireless connection manager 26, and the wireless communication units 30. The transceiver unit 422 may represent a unit configured to establish and maintain the wireless connection between the source device 12 and the sink device 14. The transceiver unit 422 may represent one or more receivers and one or more transmitters capable of wireless communication in accordance with one or more wireless communication protocols. The transceiver unit 422 may perform all or some portion of the operations of one or more of the wireless connection manager 26 and the wireless communication units 30.

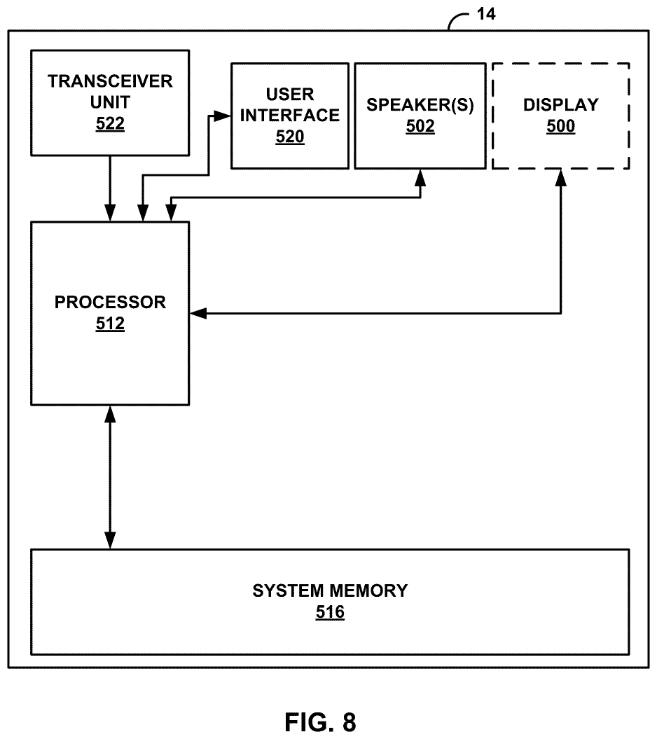

FIG. 8 is a block diagram illustrating exemplary components of the sink device 14 shown in the example of FIG. 1. Although the sink device 14 may include components similar to that of the source device 12 discussed above in more detail with respect to the example of FIG. 7, the sink device 14 may, in certain instances, include a subset of the components discussed above with respect to the source device 12.

In the example of FIG. 8, the sink device 14 includes one or more speakers 502, a processor 512, a system memory 516, a user interface 520, and a transceiver unit 522. The processor 512 may be similar or substantially similar to the processor 412. In some instances, the processor 512 may differ from the processor 412 in terms of total processing capacity or may be tailored for low power consumption. The system memory 516 may be similar or substantially similar to the system memory 416. The speakers 502, the user interface 520, and the transceiver unit 522 may be similar to or substantially similar to the respective speakers 105, user interface 420, and transceiver unit 422. The sink device 14 may also optionally include a display 500, although the display 500 may represent a low power, low resolution (potentially a black and white LED) display by which to communicate limited information, which may be driven directly by the processor 512.

The processor 512 may include one or more hardware units (including so-called “processing cores”) configured to perform all or some portion of the operations discussed above with respect to one or more of the wireless connection manager 40, the wireless communication units 42, and the audio decoder 44. The transceiver unit 522 may represent a unit configured to establish and maintain the wireless connection between the source device 12 and the sink device 14. The transceiver unit 522 may represent one or more receivers and one or more transmitters capable of wireless communication in accordance with one or more wireless communication protocols. The transceiver unit 522 may perform all or some portion of the operations of one or more of the wireless connection manager 40 and the wireless communication units 28.

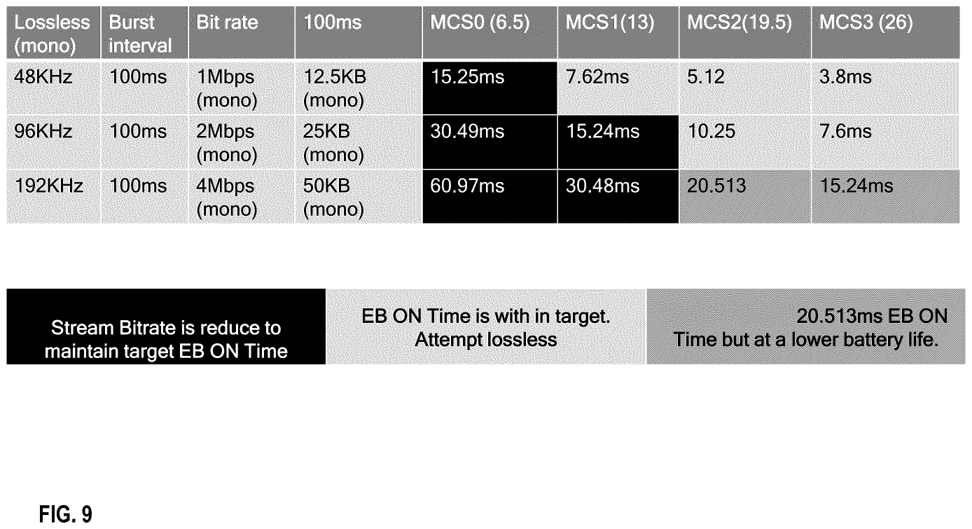

FIG. 9 is a table illustrating example wireless connection latency for various modulation modes and the impact on possible lossless audio encoding performed in accordance with various aspects of the techniques described in this disclosure. In the illustrated table, the lossless audio bitrate (for a mono audio signal) may form the basis of each row, where the lossless audio bitrates shown in the example of FIG. 9 include 48 kHz, 96 kHz, and 192 kHz. The next three column provides the burst interval, bitrate and 100 ms total encoding/transmission/decoding time for each of the three lossless audio encoding bitrates. The next four columns illustrate the impact of different wireless modulation modes (MSC0-MSC3), where black boxes indicate that lossless cannot be maintained and the stream bitrate is reduced to maintain a target time, light gray boxes indicate the total time is within target and lossless can be attempted, and the dark gray boxes indicate that 192 kHz bitrate is only satisfied from a latency perspective for MSC2 and MSC3 modulation modes.

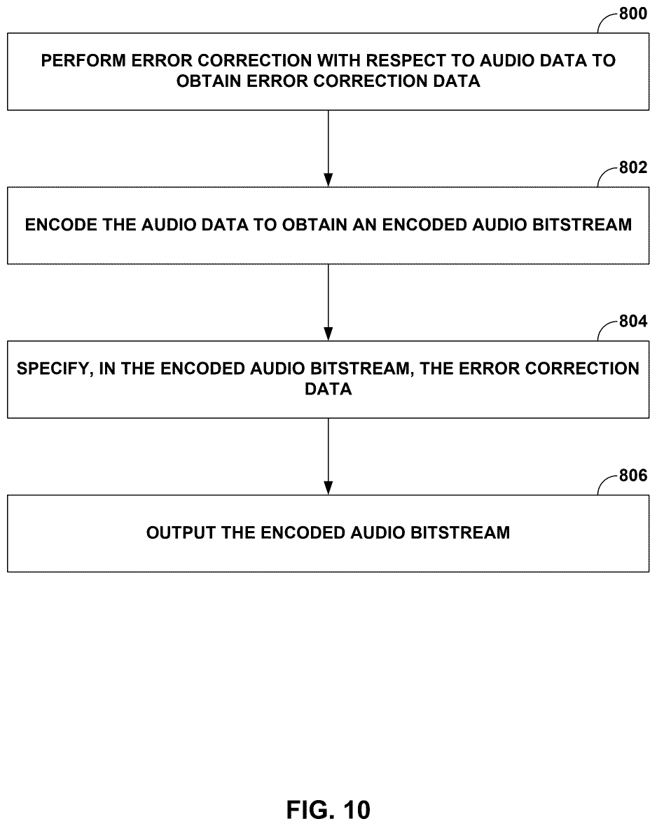

FIG. 10 is a flowchart illustrating example operation of the source device of FIG. 1 in performing various aspects of the techniques described in this disclosure. Sink device 14 may perform error correction with respect to audio data 21 to obtain error correction data (800). Sink device 14 may encode audio data 21 to obtain an encoded audio bitstream 31 (802). Sink device 14 may specify, in encoded audio bitstream 31, the error correction data (804), and output encoded audio bitstream 31 (806).

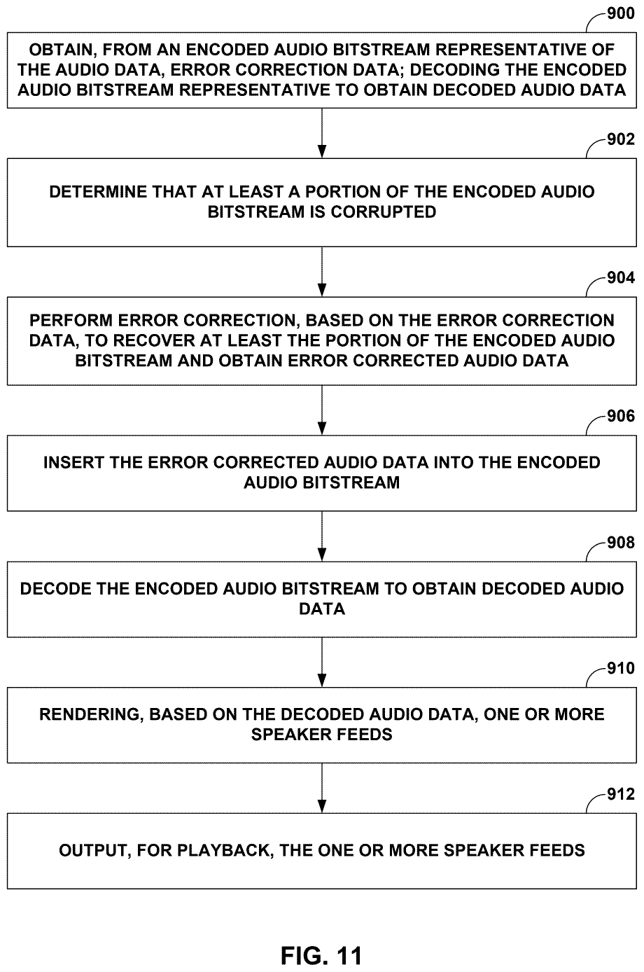

FIG. 11 is a flowchart illustrating example operation of the sink device of FIG. 1 in performing various aspects of the techniques described in this disclosure. Sink device 14 may obtain, from encoded audio bitstream 31 representative of the audio data 21, error correction data (900), and decode the encoded audio bitstream 31 to obtain decoded audio data (902). Sink device 14 may next determine that at least a portion of the encoded audio bitstream 31 is corrupted (904), and perform error correction, based on the error correction data, to recover at least the portion of the encoded audio bitstream 31 and obtain error corrected audio data (906). Sink device 14 may insert the error corrected audio data into encoded audio bitstream 31, and decode the encoded audio bitstream 31 to obtain decoded audio data (908). Sink device 14 may render, based on the decoded audio data, one or more speaker feeds (910), and output, for playback, the one or more speaker feeds (912).

In this way, the techniques may enable the following aspects.

Aspect 1A. A device configured to decode audio data, the device comprising: a memory configured to store an encoded audio bitstream representative of the audio data; and processing circuitry in communication with the memory, the processing circuitry configured to: decode the encoded audio bitstream to obtain decoded audio data; obtain, from the encoded audio bitstream, a quantization offset; apply the quantization offset to the decoded audio data to obtain corrected audio data, wherein the quantization offset corrects for any bit differences between original audio data that was encoded to obtain the encoded audio bitstream and the decoded audio data; render, based on the decoded audio data, one or more speaker feeds; and output, for playback, the one or more speaker feeds.

Aspect 2A. The device of aspect 1A, wherein the processing circuitry is configured to: obtain, from the bitstream, an entropy encoded version of the quantization offset; and perform entropy decoding with respect to the entropy encoded version of the quantization offset to obtain the quantization offset.

Aspect 3A. The device of aspect 1A, wherein the quantization offset comprises a first quantization offset corresponding to a first sample of the decoded audio data, wherein the processing circuitry is configured to: obtain, from the bitstream, an entropy encoded version of a combination of the first quantization offset and a second quantization offset corresponding to a second sample of the decoded audio data; and perform entropy decoding with respect to the entropy encoded version of the combination of the first quantization offset and the second quantization offset to obtain the first quantization offset and the second quantization offset.

Aspect 4A. The device of one of aspects 2A and 3A, wherein entropy decoding includes one of Golomb-Rice entropy decoding, Huffman entropy decoding, and arithmetic entropy decoding.

Aspect 5A. The device of any of aspects 1A-4A, wherein the processing circuitry is configured to: apply a baseline offset to a sample of the decoded audio data to which the quantization offset corresponds to obtain an adjusted sample; apply the quantization offset to the adjusted sample to obtain an offset sample; apply a bitmask to one or more bits of the offset sample of the decoded audio data to obtain a masked sample; reapply the baseline offset to the masked sample to obtain a readjusted sample; and obtain, based on residual data specified in the encoded audio bitstream and the readjusted sample, a bit accurate sample of the decoded audio data.

Aspect 6A. The device of aspect 5A, wherein the bit accurate sample of the decoded audio data is within a specified bit accuracy when compared to a corresponding sample of the original audio data.

Aspect 7A. The device of any of aspects 1A-6A, wherein the processing circuitry is further configured to: obtain, from a first sample of the encoded audio bitstream, error correction data from a subsequent second sample of the encoded audio bitstream; and perform, based on the error correction data, error correction with respect to the first sample to obtain an error corrected sample.

Aspect 8A. The device of aspect 7A, wherein the error correction comprises forward error correction.

Aspect 9A. The device of any of aspects 1A-8A, wherein the decoded audio data is dynamically adjusted based on a state of a transmission link over which the encoded audio bitstream is transmitted to the device.

Aspect 10A. The device of any of aspects 1A-9A, wherein the processing circuitry is configured to decode the encoded audio bitstream by, at least in part, applying an inverse modified discrete cosine transform to one or more samples of the encoded audio bitstream.

Aspect 11A. A method of decoding audio data, the method comprising: decoding an encoded audio bitstream representative of the audio data to obtain decoded audio data; obtaining, from the encoded audio bitstream, a quantization offset; applying the quantization offset to the decoded audio data to obtain corrected audio data, wherein the quantization offset corrects for any bit differences between original audio data that was encoded to obtain the encoded audio bitstream and the decoded audio data; rendering, based on the decoded audio data, one or more speaker feeds; and outputting, for playback, the one or more speaker feeds.

Aspect 12A. The method of aspect 11A, further comprising: obtaining, from the bitstream, an entropy encoded version of the quantization offset; and performing entropy decoding with respect to the entropy encoded version of the quantization offset to obtain the quantization offset.

Aspect 13A. The method of aspect 11A, wherein the quantization offset comprises a first quantization offset corresponding to a first sample of the decoded audio data, wherein the method further comprises: obtaining, from the bitstream, an entropy encoded version of a combination of the first quantization offset and a second quantization offset corresponding to a second sample of the decoded audio data; and performing entropy decoding with respect to the entropy encoded version of the combination of the first quantization offset and the second quantization offset to obtain the first quantization offset and the second quantization offset.

Aspect 14A. The method of one of aspects 12A and 13A, wherein entropy decoding includes one of Golomb-Rice entropy decoding, Huffman entropy decoding, and arithmetic entropy decoding.

Aspect 15A. The method of any of aspects 11A-14A, further comprising applying a baseline offset to a sample of the decoded audio data to which the quantization offset corresponds to obtain an adjusted sample, wherein applying the quantization offset comprises applying the quantization offset to the adjusted sample to obtain an offset sample, and wherein the method further comprises applying a bitmask to one or more bits of the offset sample of the decoded audio data to obtain a masked sample; reapplying the baseline offset to the masked sample to obtain a readjusted sample; and obtaining, based on residual data specified in the encoded audio bitstream and the readjusted sample, a bit accurate sample of the decoded audio data.

Aspect 16A. The method of aspect 15A, wherein the bit accurate sample of the decoded audio data is within a specified bit accuracy when compared to a corresponding sample of the original audio data.

Aspect 17A. The method of any of aspects 11A-16A, further comprising: obtaining, from a first sample of the encoded audio bitstream, error correction data from a subsequent second sample of the encoded audio bitstream; and performing, based on the error correction data, error correction with respect to the first sample to obtain an error corrected sample.

Aspect 18A. The method of aspect 17A, wherein the error correction comprises forward error correction.

Aspect 19A. The method of any of aspects 11A-18A, wherein the decoded audio data is dynamically adjusted based on a state of a transmission link over which the encoded audio bitstream is transmitted to the device.

Aspect 20A. The method of any of aspects 11A-19A, wherein decoding the encoded audio bitstream comprises decoding the encoded audio bitstream by, at least in part, applying an inverse modified discrete cosine transform to one or more samples of the encoded audio bitstream.

Aspect 21A. A computer program product including a non-transitory computer readable media storing instructions that, when executed, cause one or more processors to: decode an encoded audio bitstream representative of audio data to obtain decoded audio data; obtain, from the encoded audio bitstream, a quantization offset; apply the quantization offset to the decoded audio data to obtain corrected audio data, wherein the quantization offset corrects for any bit differences between original audio data that was encoded to obtain the encoded audio bitstream and the decoded audio data; render, based on the decoded audio data, one or more speaker feeds; and output, for playback, the one or more speaker feeds.

Aspect 1B. A device configured to encode audio data, the device comprising: a memory configured to store the audio data; and processing circuitry in communication with the memory, the processing circuitry configured to: encode the audio data to obtain an encoded audio bitstream; decode the encoded audio bitstream to obtain corresponding decoded audio data; obtain, based on the audio data and the corresponding decoded audio data, a quantization offset; specify, in the encoded audio bitstream, the quantization offset; and output the encoded audio bitstream.

Aspect 2B. The device of aspect 1B, wherein the processing circuitry is configured to: perform entropy encoding with respect to the quantization offset to obtain an entropy encoded version of the quantization offset; and specify, in the encoded audio bitstream, the entropy encoded version of the quantization offset.

Aspect 3B. The device of aspect 1B, wherein the quantization offset comprises a first quantization offset corresponding to a first sample of the decoded audio data, wherein the processing circuitry is configured to: perform entropy encoding with respect to a combination of the first quantization offset and the second quantization offset to obtain an entropy encoded version of the combination of the first quantization offset and the second quantization offset; and specify, in the encoded audio bitstream, the entropy encoded version of the combination of the first quantization offset and the second quantization offset.

Aspect 4B. The device of one of aspects 2B and 3B, wherein entropy encoding includes one of Golomb-Rice entropy encoding, Huffman entropy encoding, and arithmetic entropy encoding.

Aspect 5B. The device of any of aspects 1B-4B, wherein the processing circuitry is configured to: apply a baseline offset to a sample of the audio data to which the quantization offset corresponds to obtain an adjusted sample; obtain, based on a difference between the sample of the audio data and a corresponding sample of the decoded audio data, the quantization offset; obtain, based on the adjusted sample and the sample of the audio data, residual data; and specify, in the encoded audio bitstream, the quantization offset and the residual data.

Aspect 6B. The device of aspect 5B, wherein the quantization offset ensures the decoded audio data is within a specified bit accuracy when compared to a corresponding sample of the audio data.

Aspect 7B. The device of any of aspects 1B-5B, wherein the processing circuitry is configured to specify the quantization offset in the encoded audio bitstream to enable lossless audio decoding that ensures the decoded audio data is within a specified bit accuracy when compared to a corresponding sample of the audio data.

Aspect 8B. The device of any of aspects 1B-7B, wherein the processing circuitry is further configured to: obtain, for a first sample of the encoded audio bitstream subsequent to a second sample in the encoded audio bitstream, error correction data used to perform error correction with respect to the second sample of the encoded audio bitstream, the first sample being subsequent to the second sample in the audio encoded bitstream; and specify, for the first sample of the encoded audio bitstream, the error correction data.

Aspect 9B. The device of aspect 8B, wherein the error correction data comprises forward error correction data.

Aspect 10B. The device of any of aspects 1B-9B, wherein the encoded audio data is dynamically adjusted based on a state of a transmission link over which the encoded audio bitstream is transmitted.

Aspect 11B. The device of any of aspects 1B-10B, wherein the processing circuitry is configured to: encode the audio data by, at least in part, applying a modified discrete cosine transform to one or more samples of the audio data; and decode the audio data by, at least in part, applying an inverse modified discrete cosine transform to one or more corresponding sample of the encoded audio bitstream.

Aspect 12B. A method of encoding audio data, the method comprising: encoding the audio data to obtain an encoded audio bitstream; decoding the encoded audio bitstream to obtain corresponding decoded audio data; obtaining, based on the audio data and the corresponding decoded audio data, a quantization offset; specifying, in the encoded audio bitstream, the quantization offset; and outputting the encoded audio bitstream.

Aspect 13B. The method of aspect 12B, further comprising: performing entropy encoding with respect to the quantization offset to obtain an entropy encoded version of the quantization offset; and specifying, in the encoded audio bitstream, the entropy encoded version of the quantization offset.

Aspect 14B. The method of aspect 12B, wherein the quantization offset comprises a first quantization offset corresponding to a first sample of the decoded audio data, wherein the method further comprises: performing entropy encoding with respect to a combination of the first quantization offset and the second quantization offset to obtain an entropy encoded version of the combination of the first quantization offset and the second quantization offset; and specifying, in the encoded audio bitstream, the entropy encoded version of the combination of the first quantization offset and the second quantization offset.

Aspect 15B. The method of any of aspects 13B and 14B, wherein entropy encoding includes one of Golomb-Rice entropy encoding, Huffman entropy encoding, and arithmetic entropy encoding.

Aspect 16B. The method of any of aspects 12B-15B, further comprising: applying a baseline offset to a sample of the audio data to which the quantization offset corresponds to obtain an adjusted sample; obtaining, based on a difference between the sample of the audio data and a corresponding sample of the decoded audio data, the quantization offset; obtaining, based on the adjusted sample and the sample of the audio data, residual data; and specifying, in the encoded audio bitstream, the quantization offset and the residual data.

Aspect 17B. The method of aspect 16B, wherein the quantization offset ensures the decoded audio data is within a specified bit accuracy when compared to a corresponding sample of the audio data.

Aspect 18B. The method of any of aspects 11B-16B, wherein specifying the quantization offset comprises specifying the quantization offset in the encoded audio bitstream to enable lossless audio decoding that ensures the decoded audio data is within a specified bit accuracy when compared to a corresponding sample of the audio data.

Aspect 19B. The method of any of aspects 12B-18B, wherein the processing circuitry is further configured to: obtain, for a first sample of the encoded audio bitstream subsequent to a second sample in the encoded audio bitstream, error correction data used to perform error correction with respect to the second sample of the encoded audio bitstream, the first sample being subsequent to the second sample in the audio encoded bitstream; and specify, for the first sample of the encoded audio bitstream, the error correction data.

Aspect 20B. The method of aspect 19B, wherein the error correction data comprises forward error correction data.

Aspect 21B. The method of any of aspects 12B-20B, wherein the encoded audio data is dynamically adjusted based on a state of a transmission link over which the encoded audio bitstream is transmitted.

Aspect 22B. The method of any of aspects 12B-21B, wherein encoding the audio data comprises: encoding the audio data by, at least in part, applying a modified discrete cosine transform to one or more samples of the audio data; and decoding the audio data by, at least in part, applying an inverse modified discrete cosine transform to one or more corresponding sample of the encoded audio bitstream.

Aspect 23B. A computer program product comprising non-transitory computer readable media storing instructions that, when executed, cause one or more processors to: encode audio data to obtain an encoded audio bitstream; decode the encoded audio bitstream to obtain corresponding decoded audio data; obtain, based on the audio data and the corresponding decoded audio data, a quantization offset; specifying, in the encoded audio bitstream, the quantization offset; and outputting the encoded audio bitstream.

Aspect 1C. A device configured to decode audio data, the device comprising: a memory configured to store an encoded audio bitstream representative of the audio data; and processing circuitry in communication with the memory, the processing circuitry configured to: obtain, from the encoded audio bitstream, error correction data; determine that at least a portion of the encoded audio bitstream is corrupted; perform error correction, based on the error correction data, to recover at least the portion of the encoded audio bitstream and obtain error corrected audio data; insert the error corrected audio data into the encoded audio bitstream; decode the encoded audio bitstream to obtain decoded audio data; render, based on the decoded audio data, one or more speaker feeds; and output, for playback, the one or more speaker feeds.

Aspect 2C. The device of aspect 1C, wherein the processing circuitry is configured to determine that at least the portion of the encoded audio bitstream is corrupted when at least the portion of the encoded audio bitstream is missing.

Aspect 3C. The device of any of aspects 1C and 2C, wherein at least the portion of the encoded audio bitstream is a packet of the encoded audio data transmitted over a wireless link.

Aspect 4C. The device of any of aspects 1C-3C, wherein the processing circuitry is further configured to receive the encoded audio bitstream as a stream of packets having a defined latency requirement.

Aspect 5C. The device of any of aspects 1C-4C, wherein the error correction data comprises forward error correction data, and wherein the processing circuitry is configured to perform forward error correction, based on the forward error correction data, to reconstruct at least the portion of the encoded audio bitstream to obtain the error corrected audio data.

Aspect 6C. The device of aspect 5C, wherein the processing circuitry is configured to: apply a holes mask to identify at least the portion of the encoded audio bitstream; traverse the error correction data to determine if any of the error correction data is able to correct an error in at least the portion of the encoded audio bitstream to obtain a portion of the error correction data associated with the error in at least the portion of the encoded audio bitstream; perform the error correction, based on the portion of the error correction data, to recover at least the portion of the encoded audio bitstream and obtain the error corrected audio data.

Aspect 7C. The device of any of aspects 1C-6C, wherein the processing circuitry is configured to perform the error correction, based on the error correction data and using a jitter queue, to recover at least the portion of the encoded audio bitstream and obtain the error corrected audio data.

Aspect 8C. The device of any of aspects 1C-7C, wherein the processing circuitry is configured to perform the error correction, based on the error correction data, specifically to coarse grain energy values of at least the portion of the encoded audio bitstream to recover at least the portion of the encoded audio bitstream. Aspect 9C.

The device of any of aspects 1C-7C, wherein the processing circuitry is configured to perform the error correction, based on the error correction data, to coarse grain energy values and fine grain energy values of at least the portion of the encoded audio bitstream to recover at least the portion of the encoded audio bitstream.

Aspect 10C. The device of any of aspects 1C-9C, wherein the processing circuitry is further configured to: obtain, from a first sample of the encoded audio bitstream, error correction data for a previous second sample of the encoded audio bitstream; and perform, based on the error correction data, error correction with respect to the previous second sample to obtain at least the portion of the encoded audio bitstream.

Aspect 11C. The device of any of aspects 1C-10C, wherein the processing circuitry is further configured to: obtain, from the encoded audio bitstream, a quantization offset; and apply the quantization offset to the decoded audio data to obtain corrected audio data, wherein the quantization offset corrects for any bit differences between original audio data that was encoded to obtain the encoded audio bitstream and the decoded audio data.

Aspect 12C. The device of aspect 11C, wherein the processing circuitry is configured to: obtain, from the bitstream, an entropy encoded version of the quantization offset; and perform entropy decoding with respect to the entropy encoded version of the quantization offset to obtain the quantization offset.

Aspect 13C. The device of aspect 11C, wherein the quantization offset comprises a first quantization offset corresponding to a first sample of the decoded audio data, wherein the processing circuitry is configured to: obtain, from the bitstream, an entropy encoded version of a combination of the first quantization offset and a second quantization offset corresponding to a second sample of the decoded audio data; and perform entropy decoding with respect to the entropy encoded version of the combination of the first quantization offset and the second quantization offset to obtain the first quantization offset and the second quantization offset.

Aspect 14C. The device of one of aspects 12CA and 13C, wherein entropy decoding includes one of Golomb-Rice entropy decoding, Huffman entropy decoding, and arithmetic entropy decoding.

Aspect 15C. The device of any of aspects 11C-14C, wherein the processing circuitry is configured to: apply a baseline offset to a sample of the decoded audio data to which the quantization offset corresponds to obtain an adjusted sample; apply the quantization offset to the adjusted sample to obtain an offset sample; apply a bitmask to one or more bits of the offset sample of the decoded audio data to obtain a masked sample; reapply the baseline offset to the masked sample to obtain a readjusted sample; and obtain, based on residual data specified in the encoded audio bitstream and the readjusted sample, a bit accurate sample of the decoded audio data.

Aspect 16C. The device of aspect 15C, wherein the bit accurate sample of the decoded audio data is within a specified bit accuracy when compared to a corresponding sample of the original audio data.

Aspect 17C. The device of any of aspects 11C-16C, wherein the decoded audio data is dynamically adjusted based on a state of a transmission link over which the encoded audio bitstream is transmitted to the device.

Aspect 18C. The device of any of aspects 11C-17C, wherein the processing circuitry is configured to decode the encoded audio bitstream by, at least in part, applying an inverse modified discrete cosine transform to one or more samples of the encoded audio bitstream.

Aspect 19C. A method of decoding audio data, the method comprising: obtaining, from an encoded audio bitstream representative of the audio data, error correction data; decoding the encoded audio bitstream representative to obtain decoded audio data; determining that at least a portion of the encoded audio bitstream is corrupted; performing error correction, based on the error correction data, to recover at least the portion of the encoded audio bitstream and obtain error corrected audio data; inserting the error corrected audio data into the encoded audio bitstream; decode the encoded audio bitstream to obtain decoded audio data; rendering, based on the decoded audio data, one or more speaker feeds; and outputting, for playback, the one or more speaker feeds.

Aspect 20C. The method of aspect 19C, wherein determining that at least the portion of the encoded audio bitstream is corrupted comprises determining that at least the portion of the encoded audio bitstream is corrupted when at least the portion of the encoded audio bitstream is missing.

Aspect 21C. The method of any of aspects 19C and 20C, wherein at least the portion of the encoded audio bitstream is a packet of the encoded audio data transmitted over a wireless link.

Aspect 22C. The method of any of aspects 19C-21C, further comprising receiving the encoded audio bitstream as a stream of packets having a defined latency requirement.

Aspect 23C. The method of any of aspects 19C-22C, wherein the error correction data comprises forward error correction data, and wherein performing the error correction comprises performing forward error correction, based on the forward error correction data, to reconstruct at least the portion of the encoded audio bitstream to obtain the error corrected audio data.

Aspect 24C. The method of aspect 23C, wherein determining that at least the portion of the encoded audio bitstream is corrupted comprises: applying a holes mask to identify at least the portion of the encoded audio bitstream; traversing the error correction data to determine if any of the error correction data is able to correct an error in at least the portion of the encoded audio bitstream to obtain a portion of the error correction data associated with the error in at least the portion of the encoded audio bitstream; performing the error correction, based on the portion of the error correction data, to recover at least the portion of the encoded audio bitstream and obtain the error corrected audio data.

Aspect 25C. The method of any of aspects 19C-24C, wherein performing the error correction comprises performing the error correction, based on the error correction data and using a jitter queue, to recover at least the portion of the encoded audio bitstream and obtain the error corrected audio data.

Aspect 26C. The method of any of aspects 19C-25C, wherein performing the error correction comprises performing the error correction, based on the error correction data, only to coarse grain energy values of at least the portion of the encoded audio bitstream to recover at least the portion of the encoded audio bitstream.

Aspect 27C. The method of any of aspects 19C-25C, wherein performing the error correction comprises performing the error correction, based on the error correction data, to coarse grain energy values and fine grain energy values of at least the portion of the encoded audio bitstream to recover at least the portion of the encoded audio bitstream.

Aspect 28C. The method of any of aspects 19C-27C, wherein performing the error correction comprises: obtaining, from a first sample of the encoded audio bitstream, error correction data for a previous second sample of the encoded audio bitstream; and performing, based on the error correction data, error correction with respect to the previous second sample to obtain at least the portion of the encoded audio bitstream.

Aspect 29C. The device of any of aspects 19C-28C, further comprising: obtaining, from the encoded audio bitstream, a quantization offset; and applying the quantization offset to the decoded audio data to obtain corrected audio data, wherein the quantization offset corrects for any bit differences between original audio data that was encoded to obtain the encoded audio bitstream and the decoded audio data.

Aspect 30C. The method of aspect 29C, further comprising: obtaining, from the bitstream, an entropy encoded version of the quantization offset; and performing entropy decoding with respect to the entropy encoded version of the quantization offset to obtain the quantization offset.

Aspect 31C. The method of aspect 29C, wherein the quantization offset comprises a first quantization offset corresponding to a first sample of the decoded audio data, wherein the method further comprises: obtaining, from the bitstream, an entropy encoded version of a combination of the first quantization offset and a second quantization offset corresponding to a second sample of the decoded audio data; and performing entropy decoding with respect to the entropy encoded version of the combination of the first quantization offset and the second quantization offset to obtain the first quantization offset and the second quantization offset.

Aspect 32C. The method of one of aspects 30C and 31C, wherein entropy decoding includes one of Golomb-Rice entropy decoding, Huffman entropy decoding, and arithmetic entropy decoding.

Aspect 33C. The method of any of aspects 29C-32C, further comprising applying a baseline offset to a sample of the decoded audio data to which the quantization offset corresponds to obtain an adjusted sample, wherein applying the quantization offset comprises applying the quantization offset to the adjusted sample to obtain an offset sample, and wherein the method further comprises applying a bitmask to one or more bits of the offset sample of the decoded audio data to obtain a masked sample; reapplying the baseline offset to the masked sample to obtain a readjusted sample; and obtaining, based on residual data specified in the encoded audio bitstream and the readjusted sample, a bit accurate sample of the decoded audio data.

Aspect 34C. The method of aspect 33C, wherein the bit accurate sample of the decoded audio data is within a specified bit accuracy when compared to a corresponding sample of the original audio data.

Aspect 35C. The method of any of aspects 29C-34C, wherein the decoded audio data is dynamically adjusted based on a state of a transmission link over which the encoded audio bitstream is transmitted to the device.

Aspect 36C. The method of any of aspects 29C-35C, wherein decoding the encoded audio bitstream comprises decoding the encoded audio bitstream by, at least in part, applying an inverse modified discrete cosine transform to one or more samples of the encoded audio bitstream.

Aspect 37C. A computer program product including a non-transitory computer readable media storing instructions that, when executed, cause on or more processors to: obtain, from an encoded audio bitstream representative of audio data, error correction data; determine that at least a portion of the encoded audio bitstream is corrupted; perform error correction, based on the error correction data, to recover at least the portion of the encoded audio bitstream and obtain error corrected audio data; insert the error corrected audio data into the encoded audio bitstream; decode the encoded audio bitstream to obtain decoded audio data; render, based on the decoded audio data, one or more speaker feeds; and output, for playback, the one or more speaker feeds.

Aspect 1D. A device configured to encode audio data, the device comprising: a memory configured to store the audio data; and processing circuitry in communication with the memory, the processing circuitry configured to: perform error correction with respect to the audio data to obtain error correction data; encode the audio data to obtain an encoded audio bitstream; specify, in the encoded audio bitstream, the error correction data; and output the encoded audio bitstream to the memory.

Aspect 2D. The device of aspect 1D, wherein the processing circuitry is configured to apply a logical exclusive OR operation with respect to two samples of the audio data to obtain the error correction data.

Aspect 3D. The device of any of aspects 1D and 2D, wherein the processing circuitry is further configured output the encoded audio bitstream as the stream of packets having a defined latency requirement.

Aspect 4D. The device of any of aspects 1D-3D, wherein the error correction data comprises forward error correction data, and wherein the processing circuitry is configured to perform forward error correction with respect to the audio data to obtain the error correction data.

Aspect 5D. The device of any of aspects 1D-4D, wherein the processing circuitry is configured to perform the error correction, using a jitter queue, to obtain the error correction data.

Aspect 6D. The device of any of aspects 1D-5D, wherein the processing circuitry is configured to perform the error correction only to coarse grain energy values of the decoded audio data to obtain the error correction data.

Aspect 7D. The device of any of aspects 1D-6D, wherein the processing circuitry is configured to perform the error correction to coarse grain energy values and fine grain energy values of at least the portion of the decoded audio data to obtain the error correction data.

Aspect 8D. The device of any of aspects 1D-7D, wherein the processing circuitry is configured to specify, for a first sample of the encoded audio bitstream, the error correction data for a previous second sample of the encoded audio bitstream.

Aspect 9D. The device of any of aspects 1D-8D, wherein the processing circuitry is further configured to: decode the encoded audio bitstream to obtain decoded audio data; obtain, based on the audio data and the corresponding decoded audio data, a quantization offset; specify, in the encoded audio bitstream, the quantization offset.

Aspect 10D. The device of aspect 9D, wherein the processing circuitry is configured to: perform entropy encoding with respect to the quantization offset to obtain an entropy encoded version of the quantization offset; and specify, in the encoded audio bitstream, the entropy encoded version of the quantization offset.

Aspect 11D. The device of aspect 9D, wherein the quantization offset comprises a first quantization offset corresponding to a first sample of the decoded audio data, and wherein the processing circuitry is configured to: perform entropy encoding with respect to a combination of the first quantization offset and the second quantization offset to obtain an entropy encoded version of the combination of the first quantization offset and the second quantization offset; and specify, in the encoded audio bitstream, the entropy encoded version of the combination of the first quantization offset and the second quantization offset.

Aspect 12D. The device of one of aspects 10D and 11D, wherein entropy encoding includes one of Golomb-Rice entropy encoding, Huffman entropy encoding, and arithmetic entropy encoding.

Aspect 13D. The device of any of aspects 9D-12D, wherein the processing circuitry is configured to: apply a baseline offset to a sample of the audio data to which the quantization offset corresponds to obtain an adjusted sample; obtain, based on a difference between the sample of the audio data and a corresponding sample of the decoded audio data, the quantization offset; obtain, based on the adjusted sample and the sample of the audio data, residual data; and specify, in the encoded audio bitstream, the quantization offset and the residual data.

Aspect 14D. The device of aspect 13D, wherein the quantization offset ensures the decoded audio data is within a specified bit accuracy when compared to a corresponding sample of the audio data.

Aspect 15D. The device of any of aspects 9D-13D, wherein the processing circuitry is configured to specify the quantization offset in the encoded audio bitstream to enable lossless audio decoding that ensures the decoded audio data is within a specified bit accuracy when compared to a corresponding sample of the audio data.

Aspect 16D. The device of any of aspects 9D-15D, wherein the encoded audio data is dynamically adjusted based on a state of a transmission link over which the encoded audio bitstream is transmitted.

Aspect 17D. The device of any of aspects 9D-16D, wherein the processing circuitry is configured to: encode the audio data by, at least in part, applying a modified discrete cosine transform to one or more samples of the audio data; and decode the audio data by, at least in part, applying an inverse modified discrete cosine transform to one or more corresponding sample of the encoded audio bitstream.

Aspect 18D. A method of encoding audio data, the method comprising: performing error correction with respect to the audio data to obtain error correction data; encoding the audio data to obtain an encoded audio bitstream; specifying, in the encoded audio bitstream, the error correction data; and outputting the encoded audio bitstream to a memory.

Aspect 19D. The method of aspect 18D, wherein performing the error correction comprises applying a logical exclusive OR operation with respect to two samples of the audio data to obtain the error correction data.

Aspect 20D. The method of any of aspects 18D and 19D, wherein outputting the encoded audio bitstream comprises outputting the encoded audio bitstream as the stream of packets having a defined latency requirement.

Aspect 21D. The method of any of aspects 18D-20D, wherein performing the error correction comprises performing forward error correction with respect to the audio data to obtain forward error correction data.

Aspect 22D. The method of any of aspects 18D-21D, wherein performing the error correction comprises performing the error correction, using a jitter queue, to obtain the error correction data.

Aspect 23D. The method of any of aspects 18D-22D, wherein performing the error correction includes performing the error correction only to coarse grain energy values of the decoded audio data to obtain the error correction data.

Aspect 24D. The method of any of aspects 18D-23D, wherein the processing circuitry is configured to perform the error correction to coarse grain energy values and fine grain energy values of at least the portion of the decoded audio data to obtain the error correction data.

Aspect 25D. The method of any of aspects 18D-24D, further comprising: decoding the encoded audio bitstream to obtain decoded audio data; obtaining, based on the audio data and the corresponding decoded audio data, a quantization offset; specifying, in the encoded audio bitstream, the quantization offset.

Aspect 26D. The method of aspect 25D, further comprising: performing entropy encoding with respect to the quantization offset to obtain an entropy encoded version of the quantization offset; and specifying, in the encoded audio bitstream, the entropy encoded version of the quantization offset.

Aspect 27D. The method of aspect 25D, wherein the quantization offset comprises a first quantization offset corresponding to a first sample of the decoded audio data, and wherein the method further comprises: performing entropy encoding with respect to a combination of the first quantization offset and the second quantization offset to obtain an entropy encoded version of the combination of the first quantization offset and the second quantization offset; and specifying, in the encoded audio bitstream, the entropy encoded version of the combination of the first quantization offset and the second quantization offset.

Aspect 28D. The method of any of aspects 26D and 27D, wherein entropy encoding includes one of Golomb-Rice entropy encoding, Huffman entropy encoding, and arithmetic entropy encoding.

Aspect 29D. The method of any of aspects 25D-28D, further comprising: applying a baseline offset to a sample of the audio data to which the quantization offset corresponds to obtain an adjusted sample; obtaining, based on a difference between the sample of the audio data and a corresponding sample of the decoded audio data, the quantization offset; obtaining, based on the adjusted sample and the sample of the audio data, residual data; and specifying, in the encoded audio bitstream, the quantization offset and the residual data.

Aspect 30D. The method of aspect 29D, wherein the quantization offset ensures the decoded audio data is within a specified bit accuracy when compared to a corresponding sample of the audio data.

Aspect 31D. The method of any of aspects 25D-29D, wherein specifying the quantization offset comprises specifying the quantization offset in the encoded audio bitstream to enable lossless audio decoding that ensures the decoded audio data is within a specified bit accuracy when compared to a corresponding sample of the audio data.

Aspect 32D. The method of any of aspects 25D-31D, wherein the encoded audio data is dynamically adjusted based on a state of a transmission link over which the encoded audio bitstream is transmitted.

Aspect 33D. The method of any of aspects 25D-31D, wherein encoding the audio data comprises: encoding the audio data by, at least in part, applying a modified discrete cosine transform to one or more samples of the audio data; and decoding the audio data by, at least in part, applying an inverse modified discrete cosine transform to one or more corresponding sample of the encoded audio bitstream.

Aspect 34D. A computer program product comprising non-transitory computer readable media storing instructions that, when executed, cause one or more processors to: perform error correction with respect to audio data to obtain error correction data; encode the audio data to obtain an encoded audio bitstream; specify, in the encoded audio bitstream, the error correction data; and output the encoded audio bitstream to a memory.

The foregoing techniques may be performed with respect to any number of different contexts and audio ecosystems. A number of example contexts are described below, although the techniques should not be limited to the example contexts. One example audio ecosystem may include audio content, movie studios, music studios, gaming audio studios, channel-based audio content, coding engines, game audio stems, game audio coding/rendering engines, and delivery systems.

The movie studios, the music studios, and the gaming audio studios may receive audio content. In some examples, the audio content may represent the output of an acquisition. The movie studios may output channel-based audio content (e.g., in 2.0, 5.1, and 7.1) such as by using a digital audio workstation (DAW). The music studios may output channel-based audio content (e.g., in 2.0, and 5.1) such as by using a DAW.

In either case, the coding engines may receive and encode the channel-based audio content based one or more codecs (e.g., AAC, AC3, Dolby True HD, Dolby Digital Plus, and DTS Master Audio) for output by the delivery systems. The gaming audio studios may output one or more game audio stems, such as by using a DAW. The game audio coding/rendering engines may code and or render the audio stems into channel-based audio content for output by the delivery systems. Another example context in which the techniques may be performed comprises an audio ecosystem that may include broadcast recording audio objects, professional audio systems, consumer on-device capture, high-order ambisonics (HOA) audio format, on-device rendering, consumer audio, TV, and accessories, and car audio systems.

The broadcast recording audio objects, the professional audio systems, and the consumer on-device capture may all code their output using HOA audio format. In this way, the audio content may be coded using the HOA audio format into a single representation that may be played back using the on-device rendering, the consumer audio, TV, and accessories, and the car audio systems. In other words, the single representation of the audio content may be played back at a generic audio playback system (i.e., as opposed to requiring a particular configuration such as 5.1, 7.1, etc.), such as audio playback system 16.

Other examples of context in which the techniques may be performed include an audio ecosystem that may include acquisition elements, and playback elements. The acquisition elements may include wired and/or wireless acquisition devices (e.g., microphones), on-device surround sound capture, and mobile devices (e.g., smartphones and tablets). In some examples, wired and/or wireless acquisition devices may be coupled to mobile device via wired and/or wireless communication channel(s).

In accordance with one or more techniques of this disclosure, the mobile device may be used to acquire a soundfield. For instance, the mobile device may acquire a soundfield via the wired and/or wireless acquisition devices and/or the on-device surround sound capture (e.g., a plurality of microphones integrated into the mobile device). The mobile device may then code the acquired soundfield into various representations for playback by one or more of the playback elements. For instance, a user of the mobile device may record (acquire a soundfield of) a live event (e.g., a meeting, a conference, a play, a concert, etc.), and code the recording into various representations, including higher order ambisonic HOA representations.

The mobile device may also utilize one or more of the playback elements to playback the coded soundfield. For instance, the mobile device may decode the coded soundfield and output a signal to one or more of the playback elements that causes the one or more of the playback elements to recreate the soundfield. As one example, the mobile device may utilize the wireless and/or wireless communication channels to output the signal to one or more speakers (e.g., speaker arrays, sound bars, etc.). As another example, the mobile device may utilize docking solutions to output the signal to one or more docking stations and/or one or more docked speakers (e.g., sound systems in smart cars and/or homes). As another example, the mobile device may utilize headphone rendering to output the signal to a headset or headphones, e.g., to create realistic binaural sound.

In some examples, a particular mobile device may both acquire a soundfield and playback the same soundfield at a later time. In some examples, the mobile device may acquire a soundfield, encode the soundfield, and transmit the encoded soundfield to one or more other devices (e.g., other mobile devices and/or other non-mobile devices) for playback.

Yet another context in which the techniques may be performed includes an audio ecosystem that may include audio content, game studios, coded audio content, rendering engines, and delivery systems. In some examples, the game studios may include one or more DAWs which may support editing of audio signals. For instance, the one or more DAWs may include audio plugins and/or tools which may be configured to operate with (e.g., work with) one or more game audio systems. In some examples, the game studios may output new stem formats that support audio format. In any case, the game studios may output coded audio content to the rendering engines which may render a soundfield for playback by the delivery systems.

The mobile device may also, in some instances, include a plurality of microphones that are collectively configured to record a soundfield, including 3D soundfields. In other words, the plurality of microphone may have X, Y, Z diversity. In some examples, the mobile device may include a microphone which may be rotated to provide X, Y, Z diversity with respect to one or more other microphones of the mobile device.

A ruggedized video capture device may further be configured to record a soundfield. In some examples, the ruggedized video capture device may be attached to a helmet of a user engaged in an activity. For instance, the ruggedized video capture device may be attached to a helmet of a user whitewater rafting. In this way, the ruggedized video capture device may capture a soundfield that represents the action all around the user (e.g., water crashing behind the user, another rafter speaking in front of the user, etc.).

The techniques may also be performed with respect to an accessory enhanced mobile device, which may be configured to record a soundfield, including a 3D soundfield. In some examples, the mobile device may be similar to the mobile devices discussed above, with the addition of one or more accessories. For instance, a microphone, including an Eigen microphone, may be attached to the above noted mobile device to form an accessory enhanced mobile device. In this way, the accessory enhanced mobile device may capture a higher quality version of the soundfield than just using sound capture components integral to the accessory enhanced mobile device.

Example audio playback devices that may perform various aspects of the techniques described in this disclosure are further discussed below. In accordance with one or more techniques of this disclosure, speakers and/or sound bars may be arranged in any arbitrary configuration while still playing back a soundfield, including a 3D soundfield. Moreover, in some examples, headphone playback devices may be coupled to a decoder via either a wired or a wireless connection. In accordance with one or more techniques of this disclosure, a single generic representation of a soundfield may be utilized to render the soundfield on any combination of the speakers, the sound bars, and the headphone playback devices.

A number of different example audio playback environments may also be suitable for performing various aspects of the techniques described in this disclosure. For instance, a 5.1 speaker playback environment, a 2.0 (e.g., stereo) speaker playback environment, a 9.1 speaker playback environment with full height front loudspeakers, a 22.2 speaker playback environment, a 16.0 speaker playback environment, an automotive speaker playback environment, and a mobile device with ear bud playback environment may be suitable environments for performing various aspects of the techniques described in this disclosure.

In accordance with one or more techniques of this disclosure, a single generic representation of a soundfield may be utilized to render the soundfield on any of the foregoing playback environments. Additionally, the techniques of this disclosure enable a renderer to render a soundfield from a generic representation for playback on the playback environments other than that described above. For instance, if design considerations prohibit proper placement of speakers according to a 7.1 speaker playback environment (e.g., if it is not possible to place a right surround speaker), the techniques of this disclosure enable a render to compensate with the other 6 speakers such that playback may be achieved on a 6.1 speaker playback environment.

Moreover, a user may watch a sports game while wearing headphones. In accordance with one or more techniques of this disclosure, the soundfield, including 3D soundfields, of the sports game may be acquired (e.g., one or more microphones and/or Eigen microphones may be placed in and/or around the baseball stadium). HOA coefficients corresponding to the 3D soundfield may be obtained and transmitted to a decoder, the decoder may reconstruct the 3D soundfield based on the HOA coefficients and output the reconstructed 3D soundfield to a renderer, the renderer may obtain an indication as to the type of playback environment (e.g., headphones), and render the reconstructed 3D soundfield into signals that cause the headphones to output a representation of the 3D soundfield of the sports game.

In each of the various instances described above, it should be understood that the source device 12 may perform a method or otherwise comprise means to perform each step of the method for which the source device 12 is described above as performing. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the source device 12 has been configured to perform.

In one or more examples, the functions described may be implemented in hardware, software, firmware, or any combination thereof. If implemented in software, the functions may be stored on or transmitted over as one or more instructions or code on a computer-readable medium and executed by a hardware-based processing unit. Computer-readable media may include computer-readable storage media, which corresponds to a tangible medium such as data storage media. Data storage media may be any available media that can be accessed by one or more computers or one or more processors to retrieve instructions, code and/or data structures for implementation of the techniques described in this disclosure. A computer program product may include a computer-readable medium.

Likewise, in each of the various instances described above, it should be understood that the sink device 14 may perform a method or otherwise comprise means to perform each step of the method for which the sink device 14 is configured to perform. In some instances, the means may comprise one or more processors. In some instances, the one or more processors may represent a special purpose processor configured by way of instructions stored to a non-transitory computer-readable storage medium. In other words, various aspects of the techniques in each of the sets of encoding examples may provide for a non-transitory computer-readable storage medium having stored thereon instructions that, when executed, cause the one or more processors to perform the method for which the sink device 14 has been configured to perform.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. It should be understood, however, that computer-readable storage media and data storage media do not include connections, carrier waves, signals, or other transitory media, but are instead directed to non-transitory, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. In addition, in some examples, the functionality described herein may be provided within dedicated hardware and/or software modules configured for encoding and decoding or incorporated in a combined codec. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a codec hardware unit or provided by a collection of interoperative hardware units, including one or more processors as described above, in conjunction with suitable software and/or firmware.

Various aspects of the techniques have been described. These and other aspects of the techniques are within the scope of the following claims.

What is claimed is:

1. A device configured to decode audio data, the device comprising:
a memory configured to store an encoded audio bitstream representative of the audio data; and
processing circuitry in communication with the memory, the processing circuitry configured to:
obtain, from the encoded audio bitstream, error correction data;
determine that at least a portion of the encoded audio bitstream is corrupted;
perform error correction, based on the error correction data, to recover at least the portion of the encoded audio bitstream and obtain error corrected audio data;
insert the error corrected audio data into the encoded audio bitstream;
decode the encoded audio bitstream to obtain decoded audio data;
render, based on the decoded audio data, one or more speaker feeds; and
output, for playback, the one or more speaker feeds.

2. The device of claim 1, wherein the processing circuitry is configured to determine that at least the portion of the encoded audio bitstream is corrupted when at least the portion of the encoded audio bitstream is missing.

3. The device of claim 1, wherein at least the portion of the encoded audio bitstream is a packet of the encoded audio data transmitted over a wireless link.

4. The device of claim 1, wherein the processing circuitry is further configured to receive the encoded audio bitstream as a stream of packets having a defined latency requirement.

5. The device of claim 1,
wherein the error correction data comprises forward error correction data,
wherein the processing circuitry is configured to perform forward error correction, based on the forward error correction data, to reconstruct at least the portion of the encoded audio bitstream to obtain the error corrected audio data.

6. The device of claim 5, wherein the processing circuitry is configured to:
apply a holes mask to identify at least the portion of the encoded audio bitstream;
traverse the error correction data to determine if any of the error correction data is able to correct an error in at least the portion of the encoded audio bitstream to obtain a portion of the error correction data associated with the error in at least the portion of the encoded audio bitstream;
perform the error correction, based on the portion of the error correction data, to recover at least the portion of the encoded audio bitstream and obtain the error corrected audio data.

7. The device of claim 1, wherein the processing circuitry is configured to perform the error correction, based on the error correction data and using a jitter queue, to recover at least the portion of the encoded audio bitstream and obtain the error corrected audio data.

8. The device of claim 1, wherein the processing circuitry is configured to perform the error correction, based on the error correction data, only to coarse grain energy values of at least the portion of the encoded audio bitstream to recover at least the portion of the encoded audio bitstream.

9. The device of claim 1, wherein the processing circuitry is configured to perform the error correction, based on the error correction data, to coarse grain energy values and fine grain energy values of at least the portion of the encoded audio bitstream to recover at least the portion of the encoded audio bitstream.

10. The device of claim 1, wherein the processing circuitry is further configured to:
obtain, from a first sample of the encoded audio bitstream, error correction data for a previous second sample of the encoded audio bitstream; and
perform, based on the error correction data, error correction with respect to the previous second sample to obtain at least the portion of the encoded audio bitstream.

11. The device of claim 1, wherein the processing circuitry is further configured to:
obtain, from the encoded audio bitstream, a quantization offset; and
apply the quantization offset to the decoded audio data to obtain corrected audio data, wherein the quantization offset corrects for any bit differences between original audio data that was encoded to obtain the encoded audio bitstream and the decoded audio data.

12. The device of claim 11, wherein the processing circuitry is configured to:
obtain, from the bitstream, an entropy encoded version of the quantization offset; and
perform entropy decoding with respect to the entropy encoded version of the quantization offset to obtain the quantization offset.

13. The device of claim 12, wherein entropy decoding includes one of Golomb-Rice entropy decoding, Huffman entropy decoding, and arithmetic entropy decoding.

14. The device of claim 11,
wherein the quantization offset comprises a first quantization offset corresponding to a first sample of the decoded audio data,
wherein the processing circuitry is configured to:
obtain, from the bitstream, an entropy encoded version of a combination of the first quantization offset and a second quantization offset corresponding to a second sample of the decoded audio data; and
perform entropy decoding with respect to the entropy encoded version of the combination of the first quantization offset and the second quantization offset to obtain the first quantization offset and the second quantization offset.

15. The device of claim 11, wherein the processing circuitry is configured to:
apply a baseline offset to a sample of the decoded audio data to which the quantization offset corresponds to obtain an adjusted sample;
apply the quantization offset to the adjusted sample to obtain an offset sample;
apply a bitmask to one or more bits of the offset sample of the decoded audio data to obtain a masked sample;
reapply the baseline offset to the masked sample to obtain a readjusted sample; and
obtain, based on residual data specified in the encoded audio bitstream and the readjusted sample, a bit accurate sample of the decoded audio data.

16. The device of claim 15, wherein the bit accurate sample of the decoded audio data is within a specified bit accuracy when compared to a corresponding sample of the original audio data.

17. The device of claim 11, wherein the decoded audio data is dynamically adjusted based on a state of a transmission link over which the encoded audio bitstream is transmitted to the device.

18. The device of claim 1, further comprising one or more loudspeakers configured to reproduce, based on the one or more speaker feeds, a soundfield represented by the decoded audio data.

19. A method of decoding audio data, the method comprising:
obtaining, from an encoded audio bitstream representative of the audio data, error correction data;
decoding the encoded audio bitstream representative to obtain decoded audio data;
determining that at least a portion of the encoded audio bitstream is corrupted;
performing error correction, based on the error correction data, to recover at least the portion of the encoded audio bitstream and obtain error corrected audio data;
inserting the error corrected audio data into the encoded audio bitstream;
decode the encoded audio bitstream to obtain decoded audio data;
rendering, based on the decoded audio data, one or more speaker feeds; and
outputting, for playback, the one or more speaker feeds.

20. A device configured to encode audio data, the device comprising:
a memory configured to store the audio data; and
processing circuitry in communication with the memory, the processing circuitry configured to:
perform error correction with respect to the audio data to obtain error correction data;
encode the audio data to obtain an encoded audio bitstream;
specify, in the encoded audio bitstream, the error correction data; and
output the encoded audio bitstream to the memory.
